(19) United States
(12) Patent Application Publication
(10) Pub. No.: US 2015/0242134 A1
(43) Pub. Date: Aug. 27, 2015

(54) METHOD AND COMPUTER SYSTEM TO ALLOCATE ACTUAL MEMORY AREA FROM STORAGE POOL TO VIRTUAL VOLUME

(71) Applicant: HITACHI, LTD., Chiyoda-ku, Tokyo (JP)

(72) Inventors: Yusuke Takada, Tokyo (JP); Takuya Okamoto, Tokyo (JP); Takato Kusama, Tokyo (JP)

(21) Appl. No.: 14/426,997

(22) PCT Filed: Oct. 22, 2012
(86) PCT No.: PCT/JP2012/077267

§ 371 Date: Mar. 10, 2015

(51) Int. Cl. G06F 3/06

(52) U.S. Cl. CPC G06F 3/0613; G06F 3/0689; G06F 3/0619; G06F 3/0665; G06F 3/0635; G06F 3/067; G06F 2003/0692

(57) ABSTRACT

An example of the invention is a computer system managing actual storage areas provided by physical storage apparatuses as a single storage pool and allocating an actual storage area to a virtual volume from the storage pool when writing data to the virtual volume from the host computers. A management computer identifies, based on access path management information, access paths for access from the host computers to the virtual volume and usage status of the access paths for access to the virtual volume, and determines, based on the usage status of the access paths, target capacity ratios of actual storage areas allocated to the virtual volume from the physical storage apparatuses providing actual storage areas to the storage pool. The physical storage apparatuses allocate actual storage areas to the virtual volume based on an actual storage area capacity already allocated to the virtual volume and the target capacity ratios.

### BACKGROUND

The present invention is related to a method and a computer system to allocate an actual memory area from a storage pool to a virtual volume.

A method to manage a Thin Provisioning Pool (Dynamic Allocation Pool) and an application group which uses the same in an associated manner is disclosed in Patent Document 1, for example. According to an operation management server disclosed in Patent Document 1, in a physical storage apparatus having a virtual volume, a dynamic allocation pool, which manages the allocation of a physical storage area (physical page) to the virtual volume, is determined.

Further, the operation management server retrieves I/O (Input/Output) characteristics of an application executed at a business server, creates and maintains an application management chart which maps in a corresponding manner the application and the I/O characteristics thereof. The operation management server creates, based on the I/O characteristics of the application management chart, an application group which is generated by grouping applications which are executed at the business server, and maps in a corresponding manner the created application group with the dynamic allocation pool in order to prevent the degradation of throughput.

Patent Document 1: JP2009-238114 A

### SUMMARY

The above mentioned prior art presupposes that the physical pages of the Thin Provisioning Pool exists within a single physical storage apparatus, and implements an optimum arrangement of the physical pages inside the single physical storage apparatus. Thus, this prior art was not taken into consideration when it comes to properly arranging physical pages in a configuration in which physical pages which are to be allocated to a virtual volume may possibly be arranged in multiple physical storage apparatuses.

When physical pages in multiple physical storage apparatuses are allocated to a single virtual volume, a communication using a network among the physical storage apparatuses may be generated when a host computer accesses the virtual volume. Therefore, depending on the arrangement of the physical pages allocated to the virtual volume, the access performance to the virtual volume and the access performance of the multiple storage apparatuses as a whole may change.

An aspect of the present invention is a computer system including a plurality of physical storage apparatuses, one or more host computers and a management computer connected with one another, the management computer managing actual storage areas provided by the plurality of physical storage apparatuses as a single storage pool, the computer system allocating an actual storage area to a virtual volume used by the one or more host computers from the storage pool when writing data to the virtual volume from the host computer. The management computer is configured to retain access path management information including information of a configuration of access paths between the plurality of physical storage apparatuses and the one or more host computers, and information of usage status of the access paths. The management computer is configured to identify, based on the access path management information, access paths for access from the one or more host computers to the virtual volume and usage status of the access paths for access to the virtual volume. The management computer is configured to determine, based on the usage status of the access paths, target capacity ratios of actual storage areas allocated to the virtual volume from the plurality of physical storage apparatuses providing actual storage areas to the storage pool. The plurality of physical storage apparatuses are configured to allocate actual storage areas to the virtual volume based on an actual storage area capacity already allocated to the virtual volume from each of the plurality of physical storage apparatuses and the target capacity ratios.

According to an aspect of the present invention, it becomes possible to appropriately allocate physical pages of a plurality of physical storage apparatuses to a virtual volume.

### BRIEF DESCRIPTION OF THE DRAWINGS

FIG. 1 is a diagram schematically illustrating an example of a configuration of a computer system according to a present embodiment.

FIG. 2 is a diagram schematically illustrating an example of a configuration of a host computer according to the present embodiment.

FIG. 3 is a diagram schematically illustrating an example of a configuration of a physical storage apparatus according to the present embodiment.

FIG. 4 is a diagram schematically illustrating an example of a volume configuration according to the present embodiment.

FIG. 5 is a diagram schematically illustrating an example of a configuration of a management computer according to the present embodiment.

FIG. 6 is a diagram illustrating an example of a configuration of a path configuration management table of the management computer according to the present embodiment.

FIG. 7 is a diagram illustrating an example of a configuration of a host computer port management table at the management computer according to the present embodiment.

FIG. 8 is a diagram illustrating an example of a configuration of a path management table at the management computer according to the present embodiment.

FIG. 9 is a diagram illustrating an example of a configuration of a physical page current placement ratio management table at the management computer according to the present embodiment.

FIG. 10 is a flowchart illustrating an example of a calculation method of a physical page current placement ratio according to the present embodiment.

FIG. 11 is a diagram illustrating an example of a configuration of a physical page target placement ratio management table at the management computer according to the present embodiment.

FIG. 12 is a diagram illustrating an example of a configuration of an active—standby configuration physical page target placement ratio management table at the management computer according to the present embodiment.

FIG. 13 is a diagram illustrating an example of a configuration of a physical page dispersion ratio management table at the management computer according to the present embodiment.

FIG. 14 is a flowchart illustrating an example of a process by a storage apparatus control program according to the present embodiment.

FIG. 15A is a diagram schematically illustrating an example of a configuration of a physical page placement status display image according to the present embodiment.

FIG. 15B is a diagram schematically illustrating an example of a usage status section of an application of the physical page placement status display image according to the present embodiment.

FIG. 15C is a diagram schematically illustrating an example of a usage status section of the physical storage apparatus of the physical page placement status display image according to the present embodiment.

FIG. 15D is a diagram schematically illustrating an example of a usage status section of the host computer of the physical page placement status display image according to the present embodiment.

FIG. 16A is a diagram schematically illustrating an example of an image of a physical page placement setting (active—active configuration) according to the present embodiment.

FIG. 16B is a diagram schematically illustrating an example of an image of the physical page placement setting (active—standby configuration) according to the present embodiment.

FIG. 17 is a flowchart illustrating an example of a process to determine a physical page target placement ratio of each physical storage apparatus by a physical page target placement ratio update module according to the present embodiment.

FIG. 18 is a flowchart illustrating an example of a process to determine a target access ratio of each access path according to an access path target access ratio update module according to the present embodiment.

### DETAILED DESCRIPTION OF THE EMBODIMENTS

Hereinafter, embodiments of this invention are described with reference to the accompanying drawings. The following description and the accompanying drawings provide specific embodiments and implementations based on the principle of this invention; however, these are for understanding of this invention and are never used to interpret this invention in a limited way.

The embodiments provide explanation in sufficient detail for a person skilled in the art to implement this invention; however, it should be understood that other implementations and embodiments are available, in which modifications of the configuration or the structure, or various replacements of the elements are available without departing from the scope and the spirit of the technical idea of this invention. Accordingly, the following description should not be interpreted as limited thereto.

As will be described later, the embodiments of this invention may be implemented by software running on a general-purpose computer. Alternatively, they may be implemented by dedicated hardware or a combination of software and hardware. A program may be installed in the computer and stored in a non-transitory storage device through a program distribution server or a non-transitory storage medium.

In the following description, the information used in the embodiments is explained mainly in the form of tables; however, it does not need to be expressed in a data structure of tables but may be expressed in data structures of lists, DBs, and others. In order to indicate independency from the data structure, a table, a list, a DB, or the like may be merely referred to as information. In explaining the information, terms such as identification information, identifier, name, and ID are used; these are replaceable with one another.

Hereinafter, explanation about processing in the embodiments of this invention is provided with a subject (agent) of program; however, since a program is executed by a processor to perform predetermined processing using a memory and a communication port (communication control device), the processor can be the subject of the explanation.

The processing disclosed with the subject of program may be the processing performed by a computer or an information processing apparatus. A part or all of a program may be implemented by dedicated hardware or may be configured as a module.

A processor operates in accordance with a program to function as a functional part for performing a predetermined function. For example, the processor operates in accordance with a control program to function as a controller and operates in accordance with a management program to function as a managing part. An apparatus and a system including the processor are the apparatus and the system including these functional parts.

According to the present embodiment, a single storage pool (Thin Provisioning Pool) is established in a plurality of physical storage apparatuses, and physical storage areas (physical pages) of the plurality of physical storage apparatuses are allocated to the storage pool. According to the present embodiment, a virtual volume to which a host computer accesses is constructed on the storage pool. That is, according to the present embodiment, the physical page of the physical storage device is allocated via the storage pool. According to the present embodiment, all elements other than the virtual elements are actual elements, and the actual elements include logical elements and physical elements.

One or a plurality of host computers access the virtual volume. The host computer, for example, issues a first I/O (Input/Output) request (read or write request) with respect to a first virtual volume via a first access path which is connected to a first physical storage apparatus, and receives a response to the first I/O request from the first physical storage apparatus.

An access destination address area of the above mentioned I/O request is included at a physical page of the first physical storage apparatus or that of a second physical storage apparatus, which is different from the first physical storage apparatus. When an access destination physical page is a physical page of the second physical storage apparatus, a communication of necessary user data will be carried out between the first physical storage apparatus and the second physical storage apparatus. Therefore, when the physical page is allocated from the physical storage apparatus which is (directly) connected to the host computer via an access path, high access performance is expected from the virtual volume.

According to the present embodiment, between one or the plurality of host computers and the plurality of physical storage apparatuses, an allocation capacity target value of each physical storage, which allocates the physical page to the virtual volume, is determined based on a usage status of the plurality of access paths defined with respect to the virtual volume, and in accordance with the target values the physical pages are allocated to the virtual volume. By this, it becomes possible to appropriately allocate the physical pages in proportion to the usage status of the access path.

The information used to indicate the usage status of the access path includes, for example, a cluster configuration of the access path (host computer) indicating whether the access path is active or on standby, an algorithm to select out of a plurality of active access paths an access path to one virtual volume to be used, and an I/O measured value (for example, the number of I/O or an I/O amount per a unit of time) at a plurality of active access paths for one virtual volume. According to the present embodiment, the allocation capacity target value is determined based on one or a plurality of elements of an element indicating the usage status of the access path.

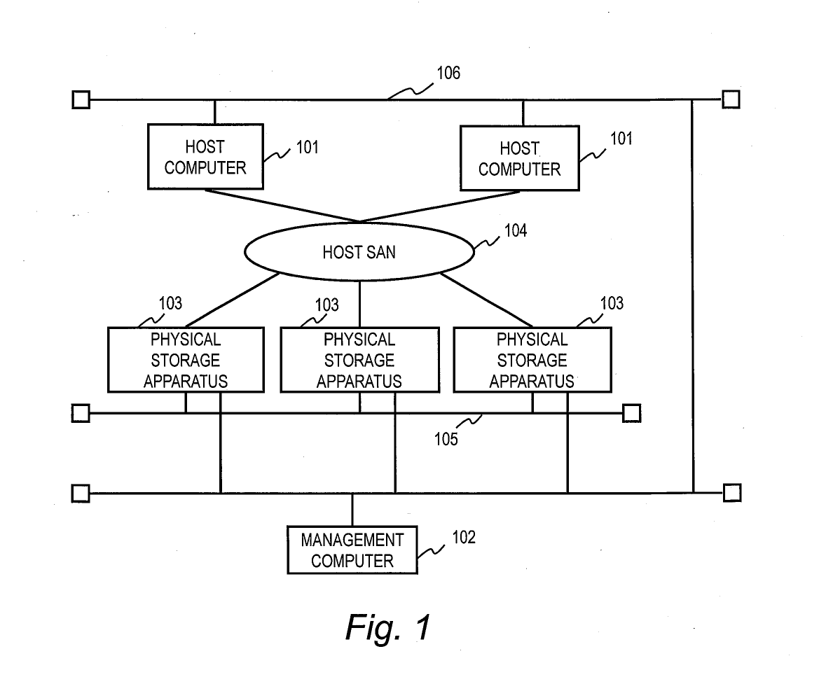

Further, according to one example of the present embodiment, a user setting is accepted in order to determine the allocation capacity target value. For example, a user is able to set an allocation capacity target value of the physical storage apparatus for which an access path for the virtual volume from the host computer does not exist, and a relation concerning the allocation capacity target values between the physical storage apparatus connected to an active path and the physical storage apparatus connected to a standby path. By this, it becomes possible to appropriately allocate the physical pages to the virtual volume in accordance with the user request. FIG. 1 is a block diagram schematically illustrating an example of a summary configuration of a computer system according to the present embodiment. The computer system includes at least one host computer 101, a management computer 102, and a plurality of physical storage apparatuses 103. According to FIG. 1, two host computers 101 and three physical storage apparatuses 103 are illustrated, however, the number for each apparatus (computer) depends on the design of the system.

The host computer 101 and the physical storage apparatus 103 are connected via a host data network 104 so as to allow communication. The data network 104 is a network for data communication between the host computer 101 and the physical storage apparatus 103. Each host computer 101 accesses to the volume of one of the physical storage apparatuses 103 via the access path (logical path) on the data network 104.

The physical storage apparatuses 103 are connected in a communicatable manner via a storage data network 105. The data network 105 is a data communication network among the physical storage apparatuses 103.

As illustrated in FIG. 1, the data networks 104 and 105 are SAN (Storage Area Network), for example. The data networks 104 and 105 may be a network different from SAN provided that they are data communication network. For example, they may be Local Area Network (LAN) or Wide Area Network (WAN). The data networks 104 and 105 may be wired network or wireless network, and may be the same network.

The host computer 101 and the physical storage apparatus 103 carry out data communication over the data networks 104 and 105 via a protocol such as Fiber Channel (FC), Internet Protocol (IP), iSCSI, or the like.

The host computer 101, the management computer 102 and the physical storage apparatus 103 are operable to carry out data communication via a management network 106. As illustrated in FIG. 1, the management network 106 is LAN, for example. Note that the management network 106 may be the same network as the networks 104 and 105.

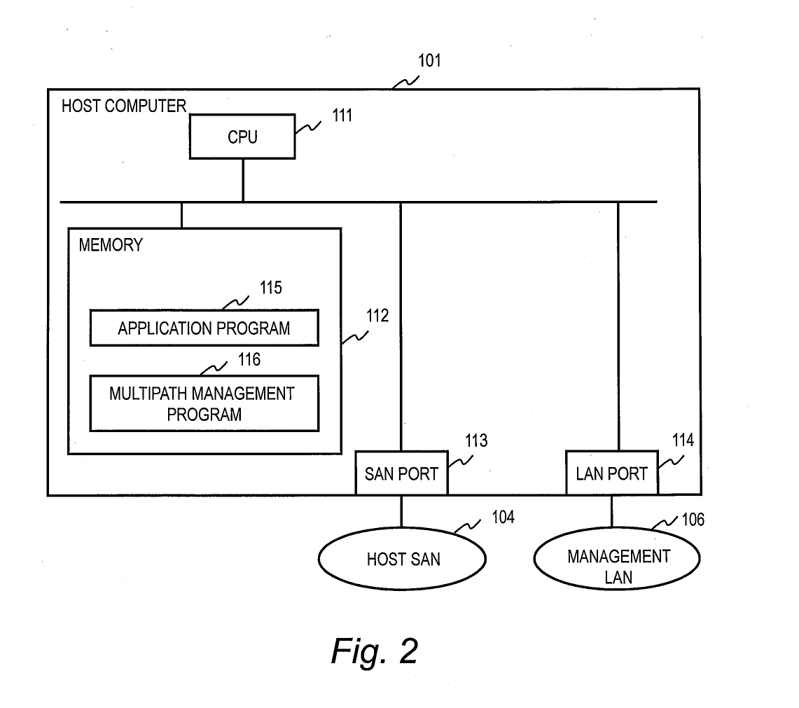

FIG. 2 is a block diagram illustrating an example of a configuration of the host computer. For example, the host computer 101 is a business server computer arranged to execute a business application program, where the business server computer (host computer 101) stores business data at the volume provided by the physical storage apparatus 103, and reads the business data from the volume.

The host computer 101 includes a CPU 111, which is a processor, a memory 112, which is a main storage device, a SAN port 113, and a LAN port 114, where they are mutually connected via an internal bus. The SAN port 113 is connected to the host network 104, while the LAN port 114 is connected to the management network 106.

The CPU 111 invokes a program stored at the memory 112, and carries out a process by operating in accordance with the program in order to implement a predetermined function of the host computer 101. The memory 112 stores therein a program which is executed by the CPU 111 and the information (data) necessary to execute the program. The memory 112 also retains therein a program different from one illustrated in FIG. 2, such as OS which is not illustrated. A program is loaded to the memory 112 via a non-volatile secondary storage device (not illustrated), or a network.

The SAN port 113 is, for example, a Host Bus Adapter (HBA), while the LAN port 114 is, for example, a Network Interface Card (NIC). The host computer 101 carries out data transmission and reception with the physical storage apparatus 103 via the host data network 104 from the SAN port 113.

According to the present example, the memory 112 retains, in addition to an application program 115, a multipath management program 116. The CPU 111 operates in accordance with the application program 115, and issues an I/O request to the physical storage apparatus 103 of an access destination via the SAN port 113 and the host SAN 104.

The multipath management program 116 manages one or a plurality of access paths which are usable for the I/O request to the one or the plurality of physical storage apparatuses 103 from the application program 115, and stores the configuration information used for selecting the access path at the access path management table (not illustrated). The multipath management program 116 refers to the access path management table and executes an access path control according to the I/O request.

The access path management table stores therein the information of an identifier of the host computer 101 to which each access path is connected, the physical storage apparatus 103 and the port thereof. Further, an identifier of a logical unit (actual volume) (LU) and the virtual volume, which are operable to data access via each access path, is stored therein. The access path management table further stores therein the information which indicates whether each path is active or on standby.

The multipath management program 116 selects one access path when accessing the virtual volume. When there are multiple active paths (multiple access paths from one or more physical storage apparatuses 103) which access the virtual volume, the multipath management program 116 selects one access path in accordance with a predetermined algorithm. When the multiple host computers 101 configure a cluster, and when a part of the host computers 101 (access path) is on standby, switching of access paths is carried out among the multiple host computers 101 (multipath management program 116).

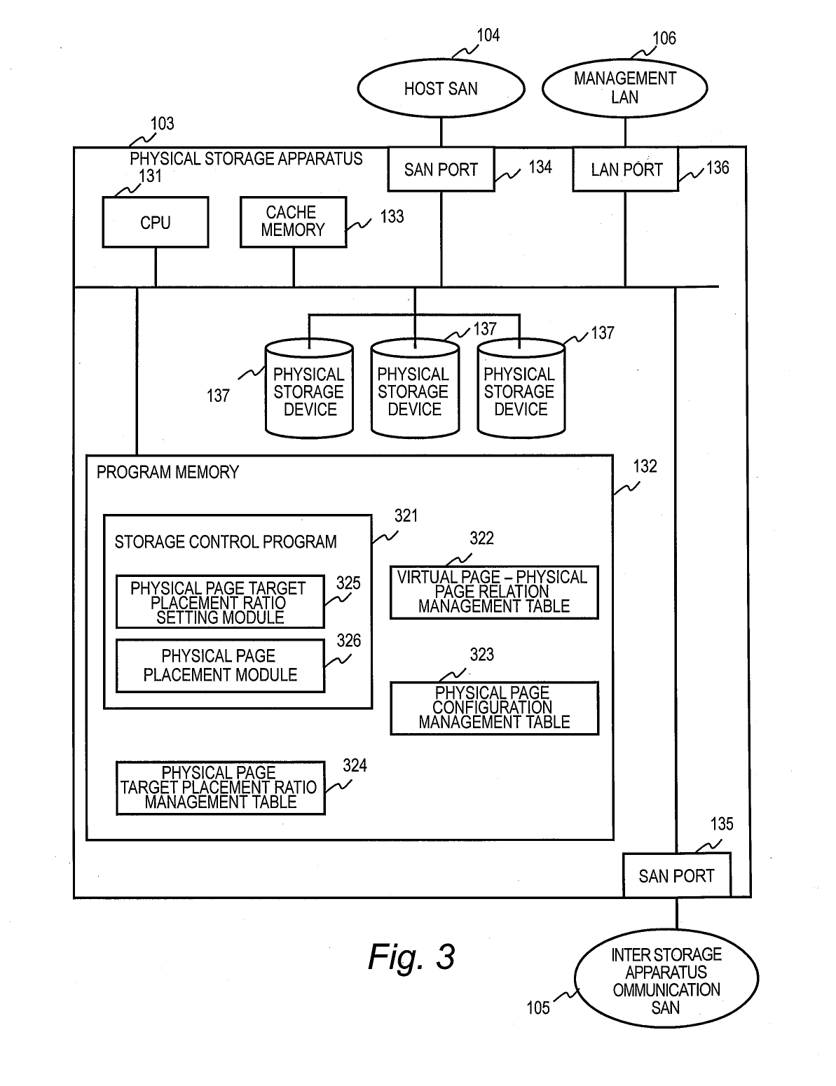

FIG. 3 is a block diagram schematically illustrating an example of a configuration of the physical storage apparatus 103. The physical storage apparatus 103 includes a plurality of physical storage devices 137 and a storage controller. The physical storage devices 137 are the same type or include physical storage devices of different types.

The storage controller includes a CPU 131, which is a processor, a program memory 132, a cache memory 133, a SAN port 134 for host communication, a SAN port 135 for communication with another physical storage apparatus 103, and a LAN port 136 to connect with the management LAN 106. They are mutually connected in a communicatable manner via an internal bus.

The CPU 131 implements, by executing a control program, a specific function which includes controlling of the I/O request from the host computer 101 or another physical storage apparatus 103, and management control of volume of the physical storage apparatus 103.

The program memory 132 stores therein the program operated by the CPU 131 or the information (data) used thereby. The CPU 131 invokes a program inside the program memory 132 which is a main storage device, and operates in accordance with the program in order to execute the process. At least one portion of the function executed by the CPU 131 may be implemented by a circuit dedicated thereto.

The cache memory 133 temporarily stores the data (user data) of the host computer 101. To be more specific, the cache memory 133 temporarily stores therein the user data (write data) from the host computer 101, and then, transfers the data to the physical storage device 137, and temporarily stores therein the user data (read data) which is transferred from the physical storage device 137 to the host computer 101.

The SAN port 134 is connected to the host SAN 104 and used for I/O with the host computer 101. The SAN port 135 is connected to the inter apparatuses communication SAN 105, and used for I/O for the communication between the physical storage apparatuses 103. The LAN port 136 is connected to the management LAN 106 and communicates with the management computer 102.

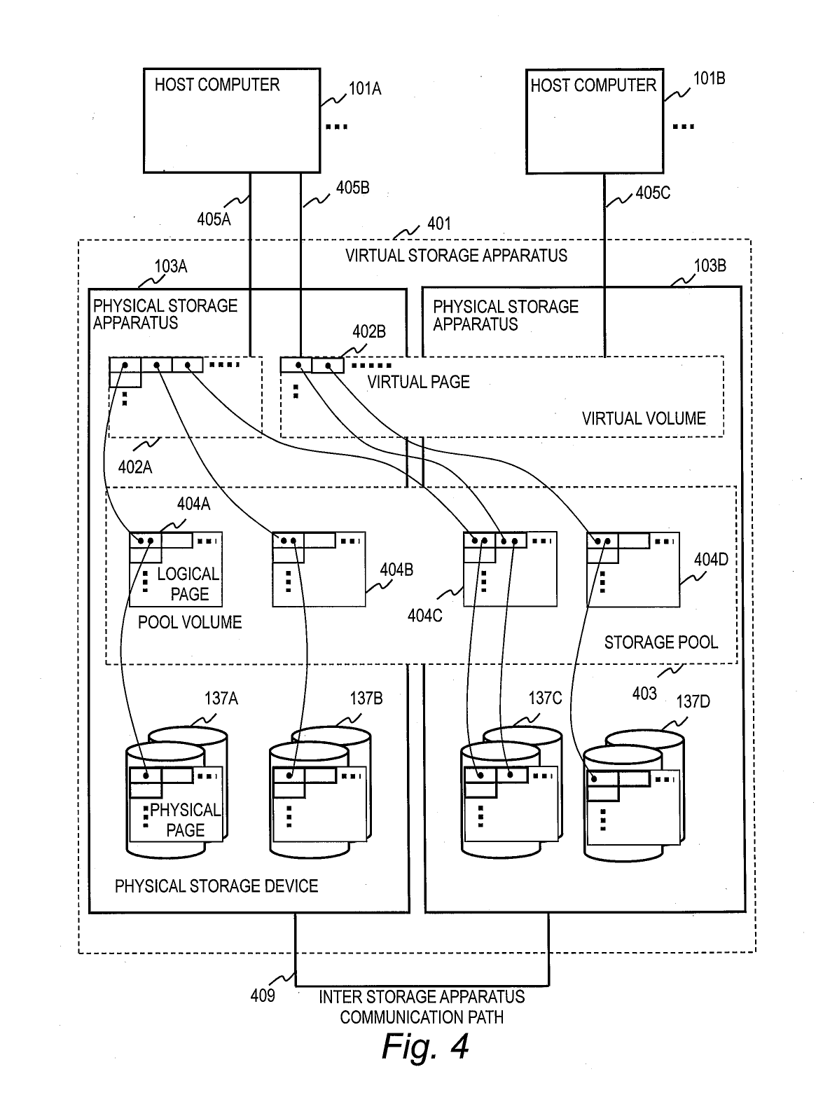

Before describing the program and the table stored at the program memory 132, the storage pool configured via the multiple physical storage apparatuses 103 and the virtual volume which is created via the storage pool and is provided to one or multiple host computers 101 will be described with reference to FIG. 4.

FIG. 4 is a block diagram for describing an actual configuration and a virtual configuration of the multiple physical storage apparatuses 103. According to the present embodiment, the multiple physical storage apparatuses 103 establish a single storage pool (Thin Provisioning Pool), wherein the virtual volume which is created over the storage pool is provided to each of one or the multiple host computers 101. As such, according to the present embodiment, the storage pool is established extending over the multiple physical storage apparatuses 103.

According to FIG. 4, two physical storage apparatuses 103A and 103B configure one virtual storage apparatus 401. Between the physical storage apparatuses 103A and 103B, and over the inter storage apparatus communication network 105, an inter storage apparatus communication path 409 is formed (defined). The physical storage apparatuses 103A and 103B are operable to carry out data communication which includes the I/O request and user data via the inter storage apparatus communication path 409.

The physical storage apparatuses 103A and 103B form the single storage pool 403, while the physical storage apparatuses 103A and 103B each provide the storage pool 403 with the physical storage areas (physical pages). According to the example in FIG. 4, the storage pool 403 is configured with a plurality of pool volumes 404A to 404D.

The pool volumes 404A and 404B are allocated with physical storage areas of the physical storage apparatus 103A, while the pool volumes 404C and the 404D are allocated with physical storage areas of the physical storage apparatus 103B.

The pool volumes 404A to 404D each are configured with a plurality of unit storage areas (pages). A page is a unit of a storage area for managing the virtual volume and the storage pool 403. In one example, a page capacity is constant. To each of the pool volumes 404A to 404D, physical pages are allocated from the physical storage devices 137A to 137D, wherein each logical page of the pool volume corresponds to the physical page of the physical storage device. In the present example, the capacity of the pool volume is not virtualized, and physical pages are allocated to all logical pages, respectively.

The physical pages (physical storage areas) in the same physical storage apparatus are allocated to the pool volume. According to the example of FIG. 4, the physical pages of the physical storage devices 137A and 137B are allocated to the pool volumes 404A and 404B, while the physical pages of the physical storage devices 137C and 137D are allocated to the pool volumes 404C and 404D.

The volume provided to the host computer 101 is a virtual volume, and its capacity is virtualized. According to the example of FIG. 4, the virtual storage apparatus 401 (physical storage apparatuses 103A and 103B) establish the virtual volumes 402A and 402B, where the virtual volume 402A is provided to the host computer 101A while the virtual volume 402B is provided to the host computers 101A and 101B. The physical storage apparatus 103 provides the virtual volume to the host computer 101 whose access path is connected to its own apparatus.

Whenever there is a writing carried out by the host computer 101A or 101B with respect to the virtual volume 402A or 402B, and a need for a data storage area, the physical storage apparatus 103A or 103B (CPU 131) allocate a logical page (actual page) of the storage pool 403 to the virtual volumes 402A or 402B.

The virtual volumes 402A and 402B each are configured with a plurality of virtual pages. To a part of or all of entire virtual pages, the logical pages (actual page) of the storage pool 403 are allocated. That is, the physical page of the physical storage device 137 is allocated to the virtual page via the logical page of the storage pool 403. As stated above, an actual page (physical page) is allocated to a virtual page when there is a need for data writing to a virtual page. A part of virtual pages may be a virtual page to which an actual page is yet to be allocated.

According to the present embodiment, the physical storage apparatuses 103A and 103B (virtual storage apparatus 401) are operable to allocate the logical page (physical page) of either of the physical storage apparatus 103A and 103B to the virtual volumes 402A and 402B. That is, they are operable to allocate the virtual volume the physical page of the physical storage apparatus 103 different from the physical storage apparatus 103 which provides the virtual volume via the access path over the host network 104.

According to the example in FIG. 4, the access path from the host computer 101 to the virtual volume 402A is defined solely by the ports of the physical storage apparatus 103A and the host computer 101A. The virtual volume 402A is defined by the physical storage apparatus 103A and provided to the host computer 101A. The host computer 101A accesses to the virtual volume 402A via the access path 405A.

According to the example in FIG. 4, the physical pages of the physical storage devices 137A to 137C are allocated to the virtual volume 402A via the logical pages of the pool volumes 404A to 404C. When there is an I/O request to the virtual page corresponding to the physical page of the physical storage device 137A or 137B at the virtual volume 402A, the physical storage apparatus 103A accesses the physical page of the physical storage device 137A or 137B.

For example, the physical storage apparatus 103A, which receives a read request to the physical page of the physical storage device 137A or 137B at the virtual volume 402A from the host computer 101A, reads data from the physical storage device 137A or 137B, and transmits the same to the host computer 101A.

On the other hand, when there is an I/O request to the virtual page corresponding to the physical page of the physical storage device 137C or 137D at the virtual volume 402A from the host computer 101A, the physical storage apparatus 103A transmits an I/O request corresponding to the I/O request to the physical storage apparatus 103B via the inter storage apparatus communication path 409. The physical storage apparatus 103B carries out a process in accordance with the received I/O request, and returns a response to the physical storage apparatus 103A.

For example, the physical storage apparatus 103A, which receives a read request to the physical page of the physical storage device 137C or 137D at the virtual volume 402A from the host computer 101A, transmits the read request to the physical page to the physical storage apparatus 103B via the inter storage apparatus communication path 409. The physical storage apparatus 103B returns the user data (read data) indicated by the received read request to the physical storage apparatus 103A. The physical storage apparatus 103A transmits the read data received from the physical storage apparatus 103B to the host computer 101A via the access path 405A.

For example, the physical storage apparatus 103A, which receives a write request to the physical page of the physical storage device 137C or 137D at the virtual volume 402A from the host computer 101A, transmits the write request to the physical page and the write data to the physical storage apparatus 103B via the inter storage apparatus communication path 409.

The physical storage. apparatus 103B returns a completion notice with respect to the received write request to the physical storage apparatus 103A via the inter storage apparatus communication path 409. The physical storage apparatus 103A returns to the host computer 101A the completion notice with respect to the write request received from the host computer 101A via the access path 405A.

According to the example in FIG. 4, a plurality of access paths to the virtual volume 402B are defined between the host computer 101 and the physical storage apparatus 103. One of them is the access path 405B between the physical storage apparatus 103A and the port of the host computer 101A, while another is the access path 405C between the physical storage apparatus 103B and the port of the host computer 101B.

The host computer 101A is operable to access the virtual volume 402B via the access path 405B, while the host computer 101B is operable to access the virtual volume 402B via the access path 405C.

For example, application programs separately executed by the host computers 101A and 101B access the virtual volume 402B. The access paths 405B and 405C each are active.

The host computers 101A and 101B are operable to configure a cluster. Application programs which are of the same type, active and executed by the host computers 101A and 101B access the virtual volume 402B (active—active configuration). The access paths 405B and 405C each are active.

Otherwise, when one of the host computers 101A and 101B is active and the other is on standby (active—standby configuration), due to an occurrence of an incident at the active host computer, the access will be switched from the active host computer to the standby host computer. By this, the access path which is actually used will be switched from the existing active path to the standby path, and thus the standby path changes into the active path.

In the virtual configuration, the virtual storage apparatus 401 provides one virtual volume 402B to the host computers 101A and 101B. In the actual configuration, the physical storage apparatuses 103A and 103B each receive and handle an I/O request to the virtual volume 402B via the access paths 405B and 405C.

The host computers 101A and 101B issue an I/O request designating the identifier of the virtual volume 402B, or an actual volume (for example, LU) corresponding to the virtual volume 402B at each of the physical storage apparatuses 103A and 103B. The physical storage apparatus 103A receives the I/O request corresponding to the virtual volume 402B from the host computer 101A, and handles the I/O request. The physical storage apparatus 103B receives the I/O request corresponding to the virtual volume 402B from the host computer 101B, and handles the I/O request.

With respect to the access to the virtual volume 402B from the host computers 101A and 101B, when the physical storage apparatuses 103A and 103B need to access the physical storage device 137 of another physical storage apparatus, as stated above, the physical storage apparatuses 103A and 103B transmit and receive the I/O request, user data and the response to the I/O request via the inter storage apparatus communication path 409.

In the example of FIG. 4, with respect to the virtual volume 402B, the physical pages of the physical storage devices 137C and 137D are allocated via the logical page of the pool volumes 404C and 404D. With respect to the virtual volume 402B, the physical pages of the physical storage devices 137A to 137D may be newly allocated.

As stated above, the I/O request to the physical page, which exists at the physical storage apparatus not connected with the access path, from the application program (host computer 101), which uses the virtual volume, is carried out by an inter physical storage apparatus communication which utilizes an inter storage apparatus communication path. Therefore, when utilizing the virtual volume, application programs do not need to be conscious of the physical storage apparatus having the physical page.

Note that in each physical storage apparatus, the plurality of physical storage devices 137 may configure a RAID (Redundant Array of Independent Disks) group. The RAID group is a plurality of devices having the same physical property grouped together. As long as the logical page is defined, there is no need to define the pool volume. The physical pages of the multiple physical storage apparatuses may be allocated to one pool volume.

The storage pool 403 may be hierarchically segmented into a plurality of storage tiers having a property different from one another. For example, a storage area of a first storage tier may be configured with storage devices of a first type such as storage areas of SSDs, and have a fast access speed. A storage area of a second storage tier may be configured with storage devices of a second type such as storage areas of HDDs (Hard Disk Drives), and have an access speed slower than the first storage tier.

A plurality of access paths with respect to a single virtual volume from a single host computer 101 may be defined. The plurality of access paths with respect to the single virtual volume from the single host computer 101 are connected to a single physical storage apparatus 103 or the plurality of the physical storage apparatuses 103.

Returning to FIG. 3, the program memory 132 of the physical storage apparatus 103 stores therein a storage control program 321, a virtual page—physical page relation management table 322, a physical page configuration management table 323, and a physical page target placement ratio management table 324. The storage control program 321 includes a physical page target placement ratio setting module 325, and a physical page placement module 326. The program memory 132 of each physical storage apparatus 103 stores them.

FIG. 3 illustrates only the programs and the information (table) necessary for the description of the present embodiment, and the program memory 132 may also stores therein an undepicted program and data including an operating system necessary for the operation of the physical storage apparatus 103. For example, the program memory 132 further stores therein the information used to manage a name, a full capacity, a used capacity, an available capacity and an utilization ratio, or the like, the information used to manage a corresponding relation between the storage pool and the virtual pool, and the information used to manage a corresponding relation between the storage pool and the pool volume, and the storage area of the physical storage device, or the like.

Further, the storage control program 321 includes a program used for handling the I/O request from the host computer 101, and a program used for managing and controlling the volume of the virtual configuration and the actual configuration.

In the storage control program 321 illustrated in FIG. 3, the physical page target placement ratio setting module 325 receives a target placement ratio of the physical pages with respect to each physical storage apparatus 103 configuring the virtual volume from the management computer 102, and updates the physical page target placement ratio management table 324.

The physical page target placement ratio management table 324 manages the physical page target placement ratio and the current physical page placement ratio of each physical storage apparatus 103 with respect to each virtual volume. The physical storage apparatus 103 notifies the number of the physical pages already allocated by its own apparatus to the virtual volume to other physical storage apparatuses 103. Each physical storage apparatus 103 calculates the physical page placement ratio based on the number of physical pages already allocated to the virtual volume by its own apparatus and other apparatuses, and updates the physical page target placement ratio management table 324.

Each physical storage apparatus 103 may retrieve a value of the current physical page placement ratio from the management computer 102. The management computer 102 retrieves the information necessary to calculate the current physical page placement ratio of each physical storage apparatus 103 from each physical storage apparatus 103, and transmits the calculated value to each physical storage apparatus 103.

When the physical page placement module 326 receives a request for a new physical page allocation with respect to the virtual volume, the physical page allocation module 326 allocates (selects a physical storage apparatus 103 from which the physical page is allocated) the physical page such that the actual placement ratio (allocation ratio) of the physical page among the physical storage apparatuses 103 becomes closer to the target placement ratio which is stored at the physical page target placement ratio management table 324.

For example, when the request for a physical page allocation is received, physical page placement module 326 determines the physical storage apparatus 103 which provides the physical page to be allocated by utilizing a function used to determine the storage apparatus 103 which places the physical page in accordance with the target placement ratios of storage apparatuses 103 configuring the virtual volume.

For example, when the physical page target place ratio management table 324 indicates that the target placement ratio of the physical storage apparatus A is 60%, the target placement ratio of the physical storage apparatus B is 30%, and the target placement ratio of the physical storage apparatus C is 10%, the aforementioned function returns a value indicating the physical storage apparatus A with a probability of 60%, returns a value indicating the physical storage apparatus B with a probability of 30%, and returns a value indicating the physical storage apparatus C with a probability of 10%.

An example will be described. When the physical storage apparatuses A, B and C configure a virtual storage apparatus, and provide a physical page to the virtual volume VOL1. Further, the target placement ratio of the VOL1 is as follows:

| Physical storage apparatus | A | B | C |
|---|---|---|---|
| Current placement ratio (%) | 10 | 30 | 60 |
| Current placement number | 10 | 30 | 60 |
| Target placement ratio (%) | 60 | 30 | 10 |
| Target placement number | 600 | 180 | 60 |

For example, the physical storage apparatus A receives the target placement ratios of all the physical storage apparatuses A, B and C from the management computer 102. The physical storage apparatus A calculates the target placement number of the physical page of the physical storage apparatus A. The physical storage apparatus A allocates the physical pages up to the calculated value of the target placement number, and stores data which is requested to be written in the allocated physical pages.

The physical storage apparatus A, after storing the data in the physical pages of the target placement number, transfers any write request thereafter to the physical storage apparatus B. The physical storage apparatus B also transfers any write request to the physical storage apparatus C after storing data up to the target placement number of the physical pages calculated by its own apparatus. The physical storage apparatus C, after storing data up to the target placement number of the physical pages calculated by its own apparatus, notifies the physical storage apparatus B that data storing at the target page number is complete.

The physical storage apparatus B, after receiving the completion notice from the physical storage apparatus C, transmits the completion notice to the physical storage apparatus A. The physical storage apparatus A receives the completion notice from the physical storage apparatus B, then, processes 60% of the write requests requiring a new physical page allocation by its own apparatus, and transfers 40% of the requests to the physical storage B. The physical storage apparatus B transfers 10% of the requests to the physical storage C.

The virtual page—physical page relation management table 322 manages the corresponding relation between the virtual page and the physical page of the virtual volume, and includes a configuration item of an identifier of the virtual volume, an identifier of the virtual page, and an identifier of the physical page, for example. With respect to each virtual page, the physical page at which the actual data thereof is stored is correlated. The virtual page—physical page relation management table 322 includes the information of all virtual volumes which the virtual storage apparatus provides, or the information of only the virtual volumes provided (connected via the access path) by the physical storage apparatus 103 which stores therein the virtual page—physical page relation management table 322.

The physical page configuration management table 323 is a table to manage the corresponding relation of the physical storage apparatus, the physical storage device and the physical page. The physical page configuration management table 323 includes a configuration item of an identifier of the physical storage apparatus, an identifier of the physical storage device, and an identifier of the physical page, for example. The physical page configuration management table 323 includes the information of all the physical storage apparatuses 103 configuring the virtual storage apparatus.

The processor 131 of the physical storage apparatus 103 is operable to refer to the virtual page—physical page relation management table 322, identify the physical page corresponding to the virtual page of the virtual volume which is the access destination of the host computer 101, and further, refer to the physical page configuration management table 323, identify the physical storage apparatus 103 and the physical storage device 137 which provide the identified physical page.

The processor 131 updates the virtual page—physical page relation management table 322 when the physical page corresponding to the virtual page is newly allocated (including when the allocation of the physical page of the virtual page is changed).

As stated above, according to the present embodiment, it is possible to allocate physical pages to a single virtual volume from the plurality of physical storage apparatuses 103. When a physical page of a physical storage 103, which is different from a physical storage apparatus 103 to which the access path is connected, is allocated, a communication between the physical storage apparatuses 103 occurs. Thus, the performance of the virtual storage apparatus (virtual volume) changes depending on from which physical storage apparatus 103 the physical page is allocated.

Hereinafter, a selection method of the physical storage apparatus 103 in the allocation of a physical page to a virtual volume (virtual volume) will be described. According to the present embodiment, the management computer 102 manages the allocation of the physical page. Although the management system according to the present configuration example is configured with the management computer 102, the management system may be configured with a plurality of computers. One of the plurality of the computers may be a computer for a display purpose, and, in order to achieve a high speed and high reliability of the management process, the plurality of the computers may implement the similar process as the management computer.

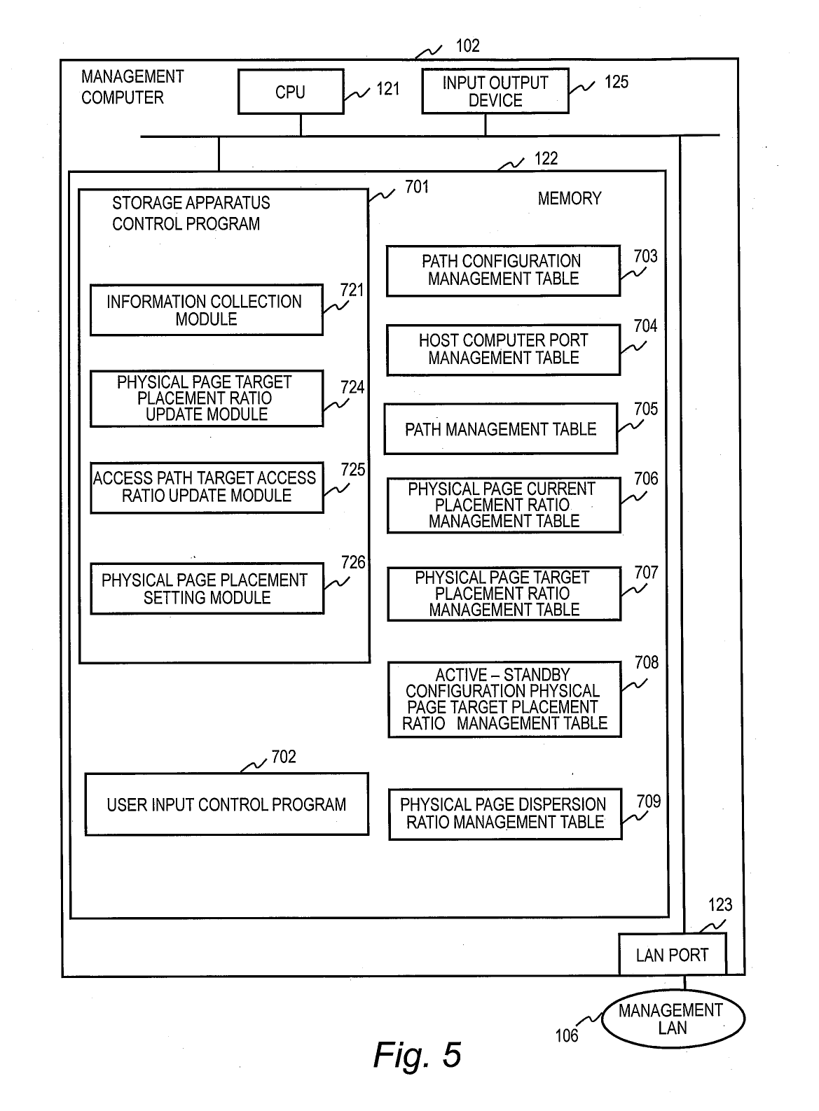

FIG. 5 is a block diagram illustrating an example of a configuration of the management computer 102. The management computer 102 includes a CPU 121 which is a processor, a memory 122 which is a main storage device, a LAN port 123, and an input output device 125, which are mutually connected to one another via an internal bus.

The LAN port 123 is, for example, NIC (Network Interface Card) and is connected to the management network 106. The input output device 125 is a device arranged to allow an administrator (user) to confirm management information and to perform user setting. The input output device 125 includes a display, a keyboard and a pointing device, for example. The input output device 125 may be a terminal device which is connected via the management network 106.

The CPU 121 invokes a program stored at the memory 122, and carries out a process by operating in accordance with the program in order to implement a predetermined function of the management computer 102. The memory 122 stores therein a program which will be executed by the CPU 121 and the information (data) necessary to execute the program. The memory 122 may also retain programs different from one illustrated in FIG. 5, such as OS which is not illustrated. A program is loaded to the memory 122 via a non-volatile secondary storage device (not illustrated), or a network.

The memory 122 stores therein a storage apparatus control program 701 and a user input control program 702. Further, the memory 122 stores a path configuration management table 703, a host computer port management table 704, a path management table 705, a physical page current placement ratio management table 706, a physical page target placement ratio management table 707, an active—standby configuration physical page target placement ratio management table 708, and a physical page dispersion ratio management table 709.

The memory 122 retains a program and data other than the program and the table illustrated in FIG. 5. For example, the memory 122 is operable to retain the information to manage the performance of the physical storage device 137 and the performance of the inter physical storage apparatus communication. This information retains the information related to the access speed of each physical storage device 137, and the information related to the access speed of each pair of a communication source port and a communication destination port 135 which are used for the communication between the physical storage apparatuses. The memory 122 further retains the information to manage a name, a full capacity, a used capacity, an available capacity and an utilization ratio, or the like of each physical storage apparatus.

The storage apparatus control program 701 carries out a process to manage and control the physical storage apparatus 103. According to the present embodiment, the storage apparatus control program 701, in particular, carries out a process to determine the physical storage apparatus which provides the physical page newly allocated to the virtual volume.

As illustrated in FIG. 5, the storage apparatus control program 701 includes an information collection module 721, a physical page target placement ratio update module 724, an access path target access ratio update module 725, and a physical page placement setting module 726. The detail of these modules will be described below.

The user input control program 702 controls a user input via a GUI (Graphic User Interface). Further, the user input control program 702 calculates an estimated access speed between the host computer 101 and the physical storage apparatus 103. This will be described below.

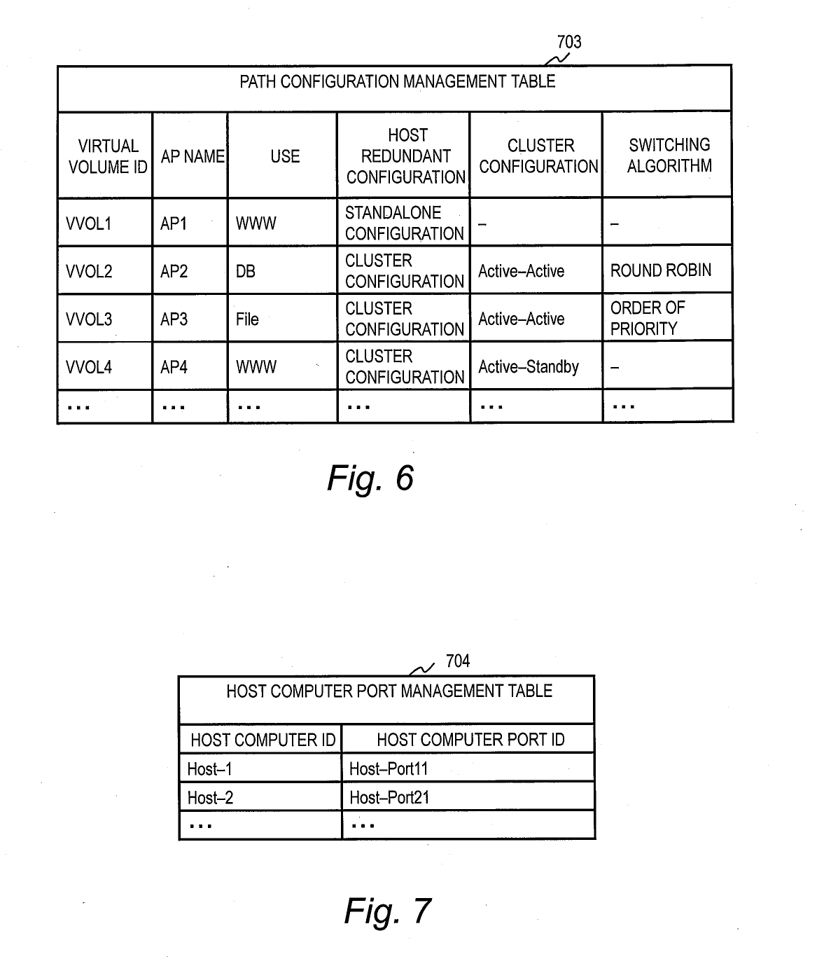

The tables retained by the memory 122 of the management computer 102 will be described. FIG. 6 illustrates an example of a configuration of the path configuration management table 703. The path configuration management table 703 manages a configuration of the access path between the host computer 1 and the virtual volume. The path configuration management table 703 includes “virtual volume ID,” “AP name,” “use,” “host redundant configuration,” “cluster configuration,” and “access algorithm” as components thereof.

The “virtual volume ID” is an identification of the virtual volume. The “AP name” is a name of an application which uses the virtual volume. The “use” is a classification of an application use (for example, DB, WWW, File, or the like). The “host redundant configuration” indicates whether one or multiple host computers 101 at which the application is executed include a Standalone configuration or a Cluster configuration.

The “cluster configuration” indicates, when the multiple host computers 101 configure a cluster, whether the cluster is an active—active configuration or an active—standby configuration. In the active—active configuration, all of the host computers 101 in the cluster are active, while in the active—standby configuration, a portion of the host computers 101 is active and the rest of the host computers 101 are on standby.

The “access algorithm” indicates, in the active—active configuration, an algorithm used by the multipath management program 116 to determine which access path will be used between the host computer 101 and the physical storage apparatus 103. Depending on the access algorithm the ratio (usage ratio) indicating to what ratio each access path is used changes. As an example, depending on such ratio, the allocation destination (the physical storage apparatus 103 which assigns the physical page) of the physical page is determined.

For example, suppose that one access path is extended to each of two different physical storage apparatuses 103 from two host computers 101. If the access algorithm is round robin, the two host computers 101 will use both of the access paths at the same ratio. The management computer 102 will determine to place the physical page equally to each of the physical storage apparatus 103 to which the access path extends.

In another example, when the access algorithm uses the access path from one of the host computers preferentially in the above mentioned configuration, the management computer 102 increases the ratio of the physical pages to be allocated to the physical storage apparatus connected to the access path which is used preferentially than the ratio of the physical pages to be allocated to the other physical storage apparatus.

The information collection module 721 retrieves the information of the host redundant configuration and the host cluster configuration from the path management table 705. The information collection module 721 is operable to retrieve the information of the access algorithm (round robin, order of priority, or the like) from the multipath management program 116 of the host computer 101.

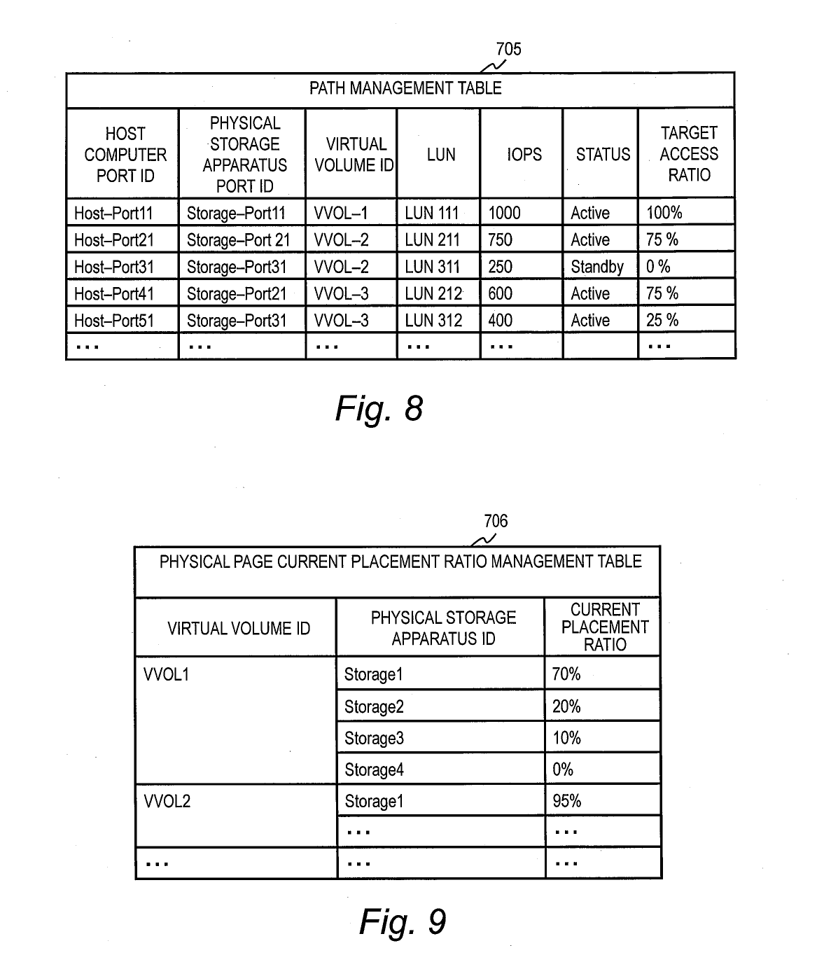

FIG. 7 illustrates an example of a configuration of the host computer port management table 704. The host computer port management table 704 manages the port of the host computer 101. The host computer port management table 704 includes “host computer ID,” and “host computer port ID” as components thereof. The “host computer ID” is an identifier of the host computer 101. The “host computer port ID” is an identifier of the SAN port 113 possessed by the host computer. The information collection module 721 retrieves this information from the host computer 101, or retrieves from a user input.

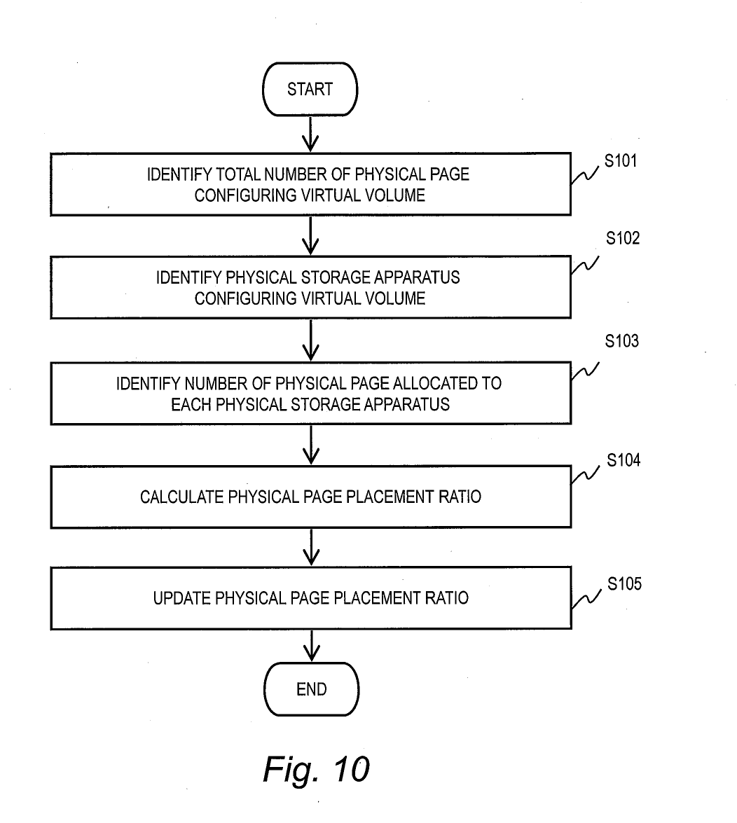

FIG. 8 illustrates an example of a configuration of the path management table 705. The path management table 705 manages the information of each access path between the host computer 101 and the physical storage apparatus 103. The path management table 705 includes “host computer port ID,” “physical storage apparatus port ID,” “virtual volume ID,” “LUN” (Logical Unit Number), “IOPS” (Input Output Per Second), “status,” “target access ratio” as configuration elements thereof.

The “host computer port ID” is an identifier of the SAN port 113 of the host computer 101 to which the access path is connected. The “storage apparatus port ID” is an identifier of the SAN port 134 of the physical storage apparatus 103 to which the access path is connected. The “virtual volume ID” is an identifier of the virtual volume which is accessed by the access path.

The “LUN” is an identifier of a logical unit (volume) defined within the physical storage apparatus 103 with respect to the virtual volume. The LUN is a unique value within a single SAN port 134. When multiple physical storage apparatuses 103 provide one virtual volume, the identifier of the virtual volume is unique in the multiple physical storage apparatuses 103. Among the physical storage apparatuses 103, the LUNs allocated to the virtual volume may be different or the same.

As stated above, the LUN may be used solely for the volume management in the physical storage apparatus 103, or used by the multipath management program 116 for the access from the host computer 101 to the virtual volume.

The “IOPS” indicates the number of I/O request (measured value) per unit time (second) of the access path. In the present example, the I/O request includes both read and write requests, but only one of them may be used. The “status” indicates whether the access path is active or on standby. The access path which is currently being used is an active path, while the access path which is currently not being used and on standby is a standby path. In a cluster, when the host computer 101 to which the access path is connected is on standby, the access path is on standby. Further, the plurality of access paths, which are connected to a single physical storage apparatus 103, may include both active and standby access paths.

The “target access ratio” is, when multiple access paths are connected to a single virtual volume, a target value of an access ratio to the virtual volume of the access path included in the multiple access paths. When there is only one access path to the virtual volume, the target access ratio to the access path is 100%.

The management computer 102 determines the target access ratio based on the IOPS, the algorithm (access algorithm) used by the multipath management program, and user setting, or the like. The management computer 102 determines the allocation ratio of the physical pages with respect to the virtual volume of each physical storage apparatus from the target access ratio of the access path. This point will be described below.

For example, the information collection module 721 is operable to retrieve the information of the “host computer port ID,” the “physical storage apparatus port ID,” the “virtual volume ID,” and the “LUN” from the user input to the physical storage apparatus 103, the host computer 101 or the management computer 102. The information collection module 721 is operable to retrieve the information of the “IOPS” from the host computer 101 or the physical storage apparatus 103, and the “status” from the host computer 101. The “target access ratio” is calculated and updated by the access path target access ratio update module 725 at the management computer 102. The detail of this calculation method will be described below.

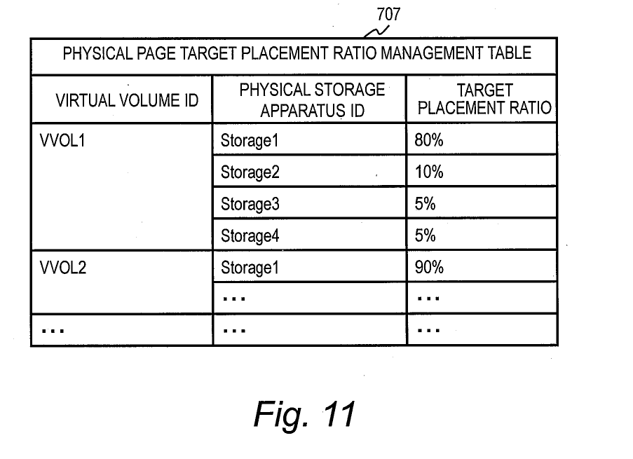

FIG. 9 illustrates an example of a configuration of the physical page current placement ratio management table 706. The physical page current placement ratio management table 706 manages, with respect to all of the physical pages that currently configure the virtual volume, the ratio of the number of physical pages each physical storage apparatus 103 provides. The physical page current placement ratio management table 706 includes “virtual volume ID,” “physical storage apparatus ID” and “current placement ratio” as components thereof.

The “virtual volume ID” is an identifier of the virtual volume. The “physical storage apparatus ID” is an identifier of the physical storage apparatus. The “current placement ratio” is, with respect to all of the physical pages allocated to the virtual volume, a ratio of the physical pages provided by each physical storage apparatus.

The information collection module 721 retrieves the information of the physical page current placement ratio management table 706 from the physical storage apparatus 103, and updates the physical page current placement ratio management table 706.

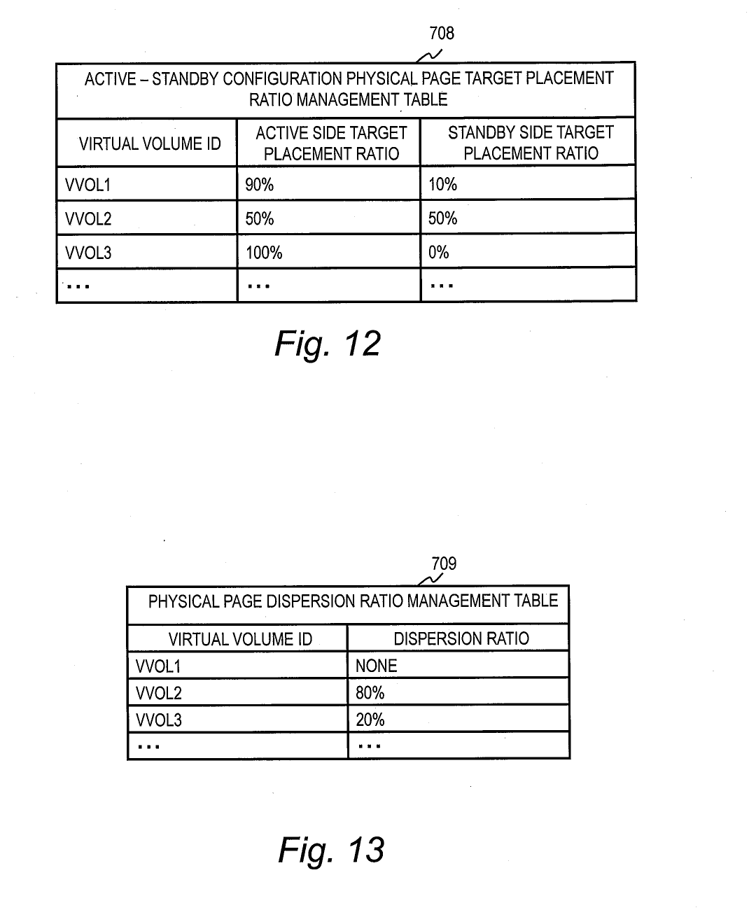

The calculation method for the physical page current placement ratio will be described with reference to the flowchart in FIG. 10. The physical page current placement ratio is a ratio of the number of the physical pages of eachof the physical storages 103 configuring the virtual volume with respect to the number of all of the physical pages placed at the physical storage apparatuses 103.

The information collection module 721 retrieves the total number of physical page already allocated to the virtual volume from the information retrieved from the physical storage apparatus 103 (S101). For example, the information collection module 721 is operable to retrieve it from the information of the virtual page—physical page relation management table 322.

Next, the information collection module 721 identifies the identifier of the physical storage apparatus configuring the virtual volume upon referring to the information retrieved from the physical storage apparatus 103 (S 102). For example, the information which is referred to is the information indicated by the virtual page—physical page relation management table 322, and the physical page configuration management table 323. The information collection module 721 further identifies the number of physical page allocated from each physical storage apparatus 103 (S103).

The information collection module 721 calculates the physical page placement ratio from the retrieved information (S 104), and updates the physical page current placement ratio management table 706 (S105). The ratio may be calculated from the formula below:

(ratio of the physical pages placed at physical apparatus X)=(number of physical pages placed at storage apparatus X)/(total number of physical pages)

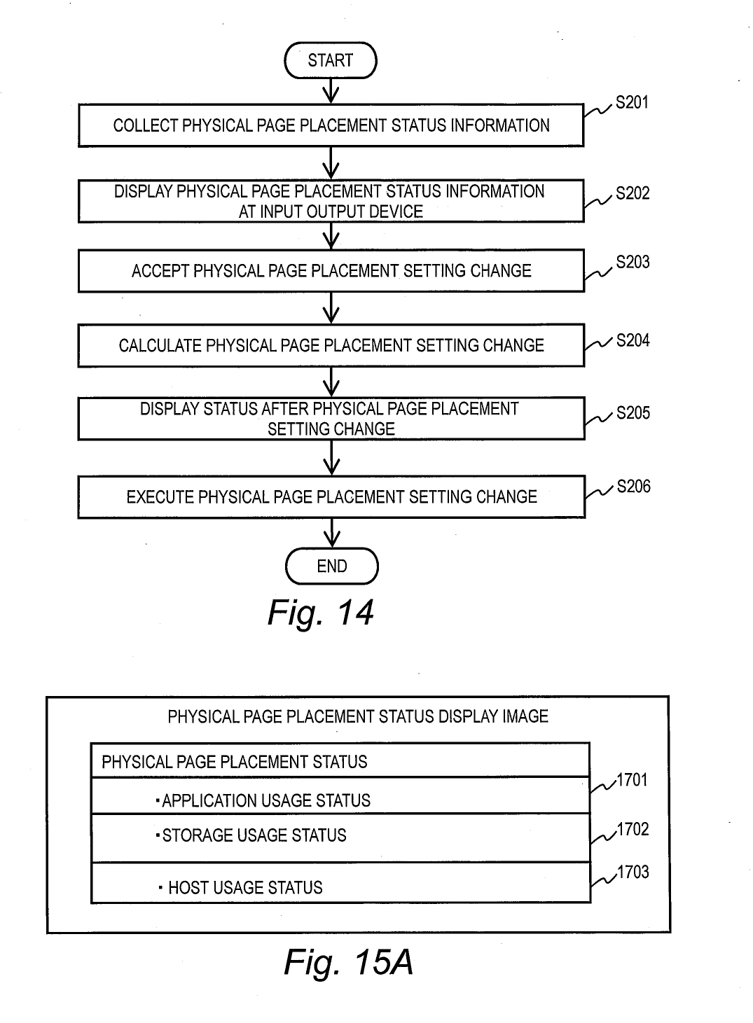

FIG. 11 illustrates an example of a configuration of the physical page target placement ratio management table 707. The physical page target placement ratio management table 707 manages the target value of the ratio of the number of physical pages provided by each physical storage apparatus 103 with respect to all of the physical pages allocated to the virtual volume. The physical pages are placed in the physical storage apparatuses 103 to reach the target placement ratios stored at the table 707 (the physical page is provided from the physical storage apparatus 103).

The physical page target placement ratio management table 707 includes “virtual volume ID,” “physical storage apparatus ID,” and “target placement ratio” as components thereof. The “virtual volume ID” is an identifier of the virtual volume. The “physical storage apparatus ID” is an identifier of the storage apparatus. The “target placement ratio” is, with respect to all of the physical pages allocated to the virtual volume, a target value of the ratio of the number of the physical pages provided by each physical storage apparatus.

The “virtual volume ID” and the “physical storage apparatus ID” are the same as the physical page current placement ratio management table 706. The physical page target placement ratio update module 724 calculates the target placement ratio from the target access ratio of the access path, and updates the physical page target placement ratio management table 707. The detail of the calculation method of the target placement ratio will be described below.

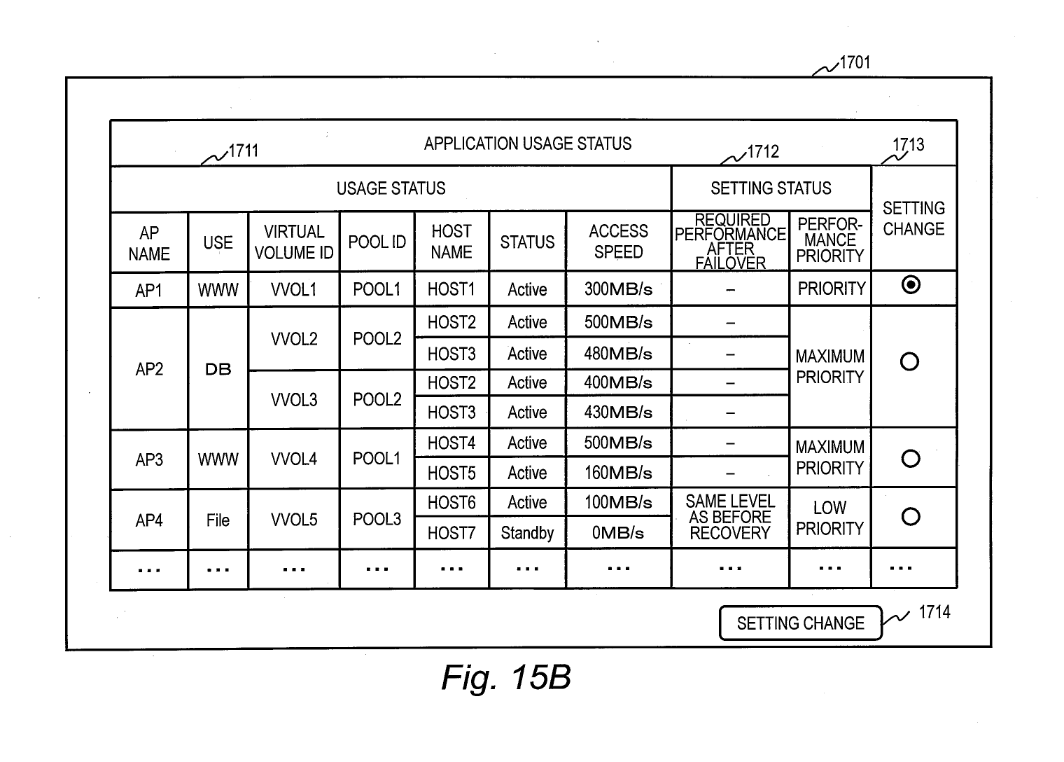

FIG. 12 illustrates an example of a configuration of the active—standby configuration physical page target placement ratio management table 708. The active—standby configuration physical page target placement ratio management table 708 manages, in the cluster, the target value of the ratio (active side target placement ratio) of the physical page placed at the physical storage apparatus 103 connected by the active host computer 101 (application program) via the access path, and the ratio (standby side target placement ratio) of the physical page placed at the physical storage apparatus 103 connected by the standby host computer 101 (application program) via the access path.

In the access from the host computer 101, the access to the physical page of the physical storage apparatus 103 connected by access path of the host SAN 103 has a faster access speed (higher access performance) than the access to the physical page of the physical storage apparatus 103 to which there is no access path. Therefore, these allocation ratios have a correlation with the required performance after a failover of coping with a failure.

For example, when the active side target placement ratio:standby side target placement ratio is 50:50, the access performance to the virtual volume after a failover may be expected to maintain at the same level as before the failover. On the other hand, when the active side target placement ratio>standby side target placement ratio, there is a possibility that the access performance may be lowered after a failover.

The active—standby configuration physical page target placement ratio management table 708 includes “virtual volume ID,” “active side target placement ratio” and “standby side target placement ratio” as components thereof.

The “virtual volume ID” is an identifier of the virtual volume. The “active side target placement ratio” is a target value of the ratio of the physical pages placed at the physical storage apparatus 103 connected by the active host computer 101 (application program) via the access path.

The “standby side target placement ratio” is a target value of the ratio of the physical pages placed at the physical storage apparatus 103 connected by the standby host computer 101 (application program) via the access path. In an example described below, the “active side target placement ratio” and the “standby side target placement ratio” are determined by a user input (user setting) via the GUI.

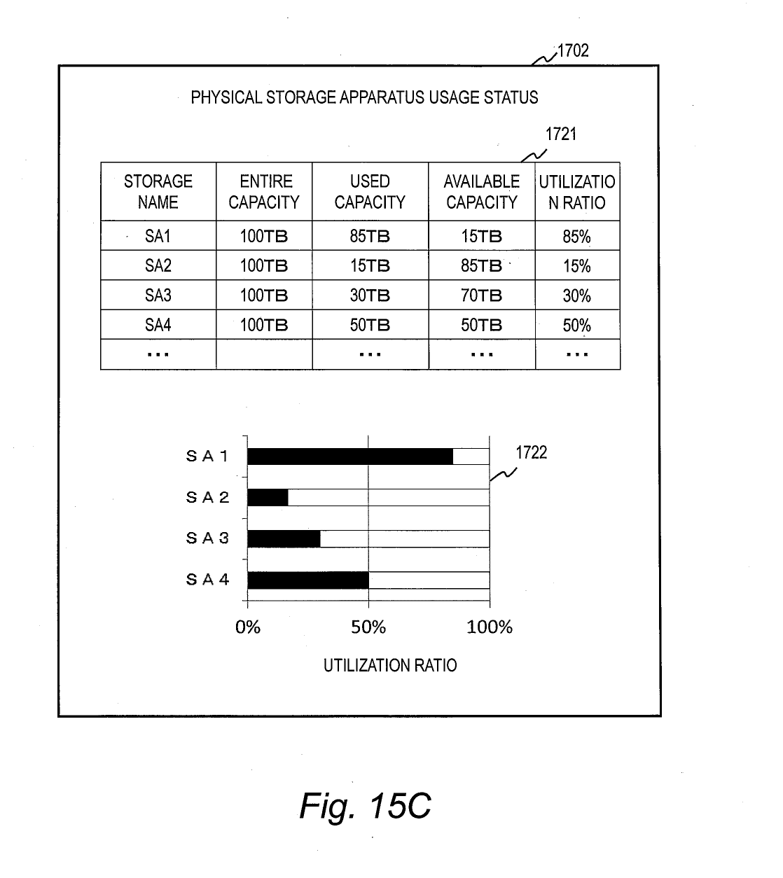

FIG. 13 illustrates an example of a configuration of the physical page dispersion ratio management table 709. The physical page dispersion ratio management table 709 is a table arranged to manage whether the physical pages are placed at a specific physical storage apparatus 103 in a concentrated manner, or dispersed at multiple physical storage apparatuses 103.

The physical page dispersion ratio management table 709 includes “virtual volume ID” and “dispersion ratio” as components thereof. The “virtual volume ID” is an identifier of the virtual volume. The “dispersion ratio” is a value indicating the ratio at which the physical pages are placed in a dispersed manner to multiple physical storage apparatuses 103.

When the physical pages are concentrated at one or more specific physical storage apparatuses, the ratio becomes closer to 0% (low dispersion ratio), and when the degree at which the physical pages being dispersed to all of the physical storage apparatuses configuring the virtual storage apparatus becomes greater, the value becomes closer to 100%. When the numbers of physical pages at all of the physical storage apparatuses are equal (matching the average value) the dispersion ratio is 100%.

The higher the dispersion ratio is, the more dispersed the load on the physical storage apparatus 103 becomes. On the other hand, the lower the dispersion ratio is, the higher the access performance to the virtual volume becomes. In an example described below, the dispersion ratio is determined by a user input (user setting) via the GUI.

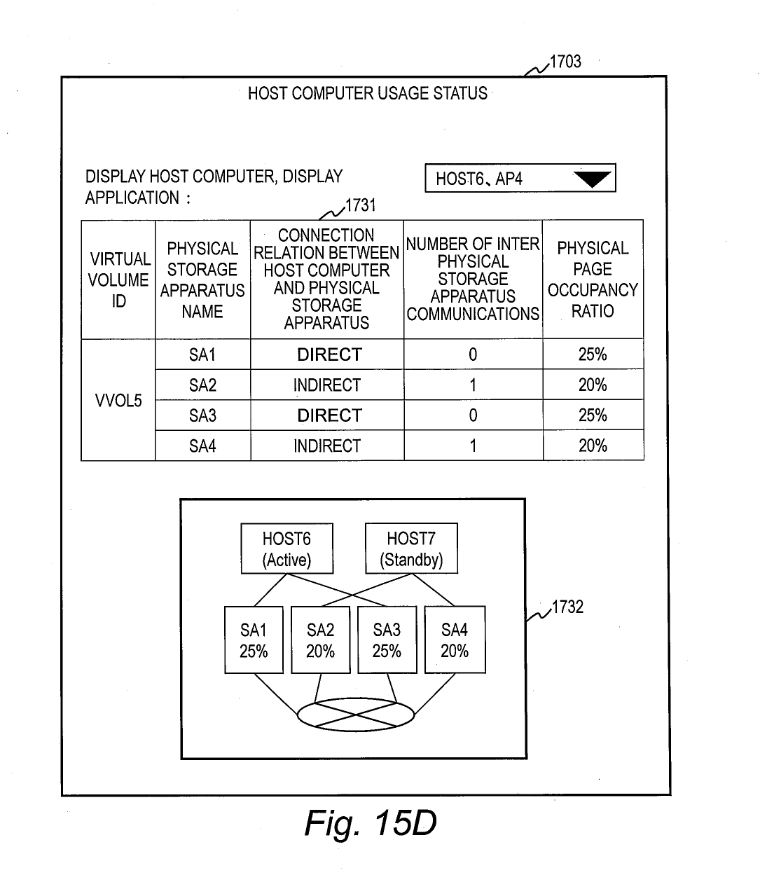

FIG. 14 is a flowchart indicating an example of a process at the storage apparatus control program 701. The storage apparatus control program 701 determines the physical page target placement ratio at the virtual volume by this flow.

In the flowchart of FIG. 14, the information collection module 721 collects physical page placement status information periodically or in response to an event such as a user instruction, or the like (S201). To be more specific, the information collection module 721 retrieves management information of the access path from the host computer 101, and updates the path configuration management table 703, the host computer port management table 704, and the path management table 705.

The information collection module 721 retrieves the information regarding the volume (including virtual volume and pool volume), the storage pool, and the page (including virtual page and physical page) from the physical storage apparatuses 103, and updates the path management table 705 and the physical page current placement ratio management table 706, or the like. Further, the information collection module 721 updates the information of the capacity and the performance (communication performance of the host computer 101 and other physical storage apparatus 103) of the physical storage apparatuses 103.

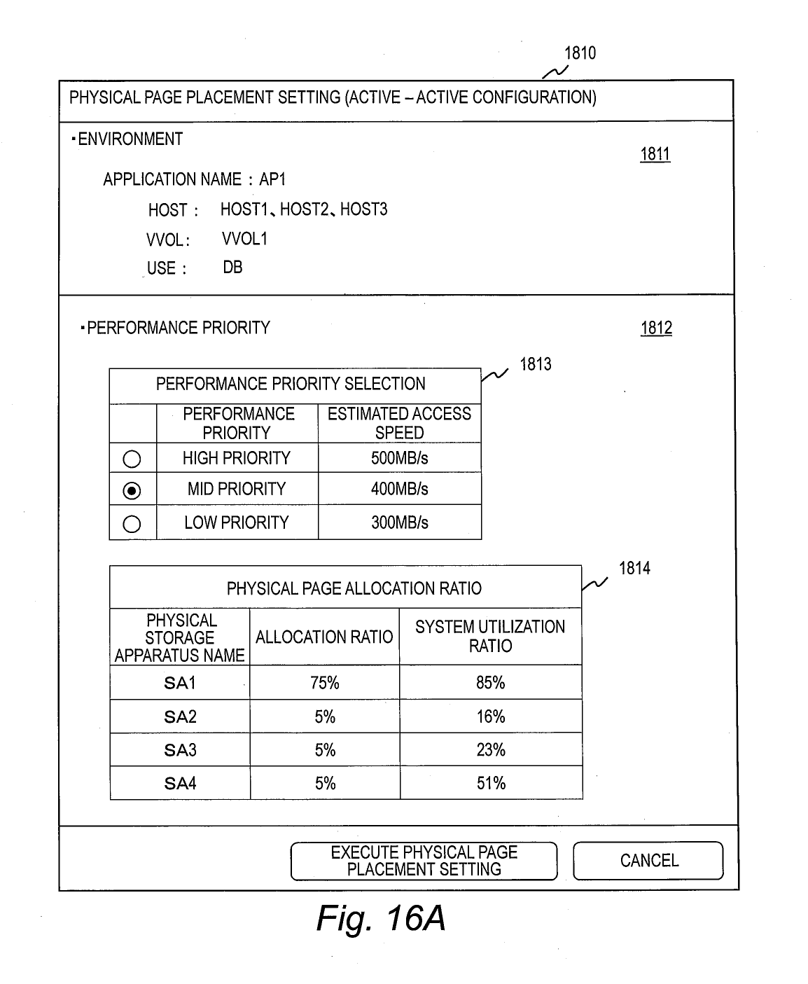

In accordance with an instruction from the user via the input output device 125, the user input control program 702 displays the information of the physical page placement status at the virtual storage apparatus via the input output device 125 (S202). FIGS. 15A to 15D indicate an example of a screen image indicating the information of the physical page placement status. A display image of the physical page placement status shows the current placement status of the physical pages, and accepts the user setting regarding the physical page placement. The user may learn the current placement status of the physical page, and modify necessary settings.

FIG. 15A schematically indicates an entire configuration of the physical page placement status display image. The physical page placement status display image includes an application usage status section 1701, a storage usage status. section 1702, and a host usage status section 1703. FIGS. 15B to 15D each indicate an example of the application usage status section 1701, the storage usage status section 1702 and the host usage status section 1703. By this, it becomes possible for the user to confirm the current status from three different perspectives. Note that only the application usage status section 1701 may be displayed, for example.

In the example of FIG. 15B, the application usage status section 1701 displays the information of the usage status and the setting of each virtual volume to which each application program accesses. To be more specific, the application usage status section 1701 includes a column for “usage status” 1711, a column for “setting status” 1712, a column for “setting change” 1713, and a setting change button 1714.

The “usage status” column 1711 indicates a use for each application program, an identifier of the virtual volume to be used by the application program, an identifier of the storage pool to which the virtual volume belongs, a name of the host computer 101 which uses the virtual volume, the status of the host computer 101 (active or standby), and an access speed from the host computer 101 to the virtual volume.

The “setting status” column 1712 indicates a required performance after a failover when the host computer 101 is included in a cluster of an active—standby configuration, and a performance priority which expresses a degree of performance required of the virtual volume. Note that the required performance after a failover and the performance priority of the virtual volume are the values specified by the user.

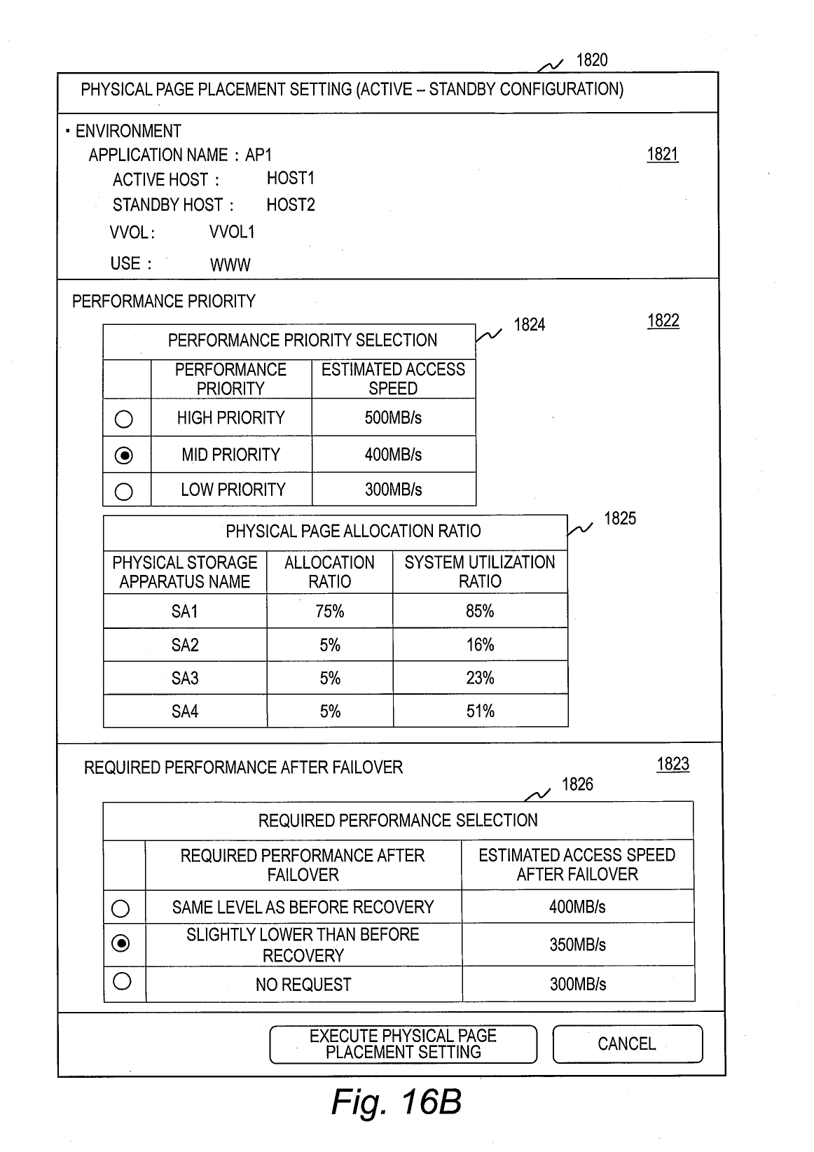

The “setting change” column 1713 includes a radio button for changing the setting of each virtual volume. The user may, by pressing the setting change button 1714 by using the input output device 125, change the setting related to the virtual volume for which the radio button of the “setting change” column 1713 was checked. The GUI for the setting change will be described below with reference to FIGS. 16A and 16B.

The user input control program 702 is operable to retrieve the information which will be displayed on the application usage status section 1701 from the information which is retrieved in advance from the host computer 101 and the physical storage apparatus 103. For example, besides the path configuration management table 703, the host computer port management table 704, and the path management table 705, the user input control program 702 is operable to retrieve necessary information from the information of the relation between the virtual volume and the storage pool, the performance of the physical storage apparatus, and the communication performance of the inter physical storage apparatuses.

Further, the user input control program 702 calculates the speed of the access from each host computer 101 to each virtual volume. The user input control program 702 calculates the access speed with respect to a specific host computer from the relation among the path between the host computer 101 and the physical storage apparatus port, the placement ratio of the number of physical pages which is placed at each storage apparatus with respect to an entire number of the physical page, the performance of the storage apparatus, and the performance of the inter storage apparatuses.

In order to calculate the access speed, the user input control program 702 retrieves the performance value of each physical storage apparatus 103. The performance value, which is a value determined by the specification of each physical storage apparatus 103, is retrievable from each physical storage apparatus 103. The performance value of the physical storage apparatus 103 includes a performance value of the communication with the host computer 101, and a performance value of the communication with another physical storage apparatus 103.

When an access path is extended from the host computer 101 to the physical storage apparatus 103, the user input control program 702 uses a value of the communication performance between the host of the physical storage apparatus 103 and the physical storage apparatus 103. When an access path does not extend from the host computer 101, the user input control program 702 uses a value of the communication performance between the physical storage apparatus 103 and another physical storage apparatus 103.

The user input control program 702 is operable to calculate an access speed from the performance value of each physical storage apparatus 103 and the ratio of the physical page placed at the physical storage apparatus 103. For example, the user input control program 702 calculates the access speed from the following formula.

Access speed=Σ{(ratio of the number of physical pages placed at physical storage apparatus X with respect to entire number of physical pages)*min {(host communication performance of physical storage apparatus X), (inter physical storage apparatus communication performance of physical storage apparatus X)}}

Here, Σ denotes the sum regarding all of the physical storage apparatuses 103 configuring the virtual storage apparatus. “min {(performance of physical storage apparatus X), (inter physical storage apparatuses communication performance)}” selects (host communication performance of physical storage apparatus X) when the inter physical storage apparatus communication does not occur, and selects (inter physical storage apparatus communication performance of physical storage apparatus X) when the inter physical storage apparatus communication occurs.

FIG. 15C illustrates a detailed example of a storage usage status section 1602. The storage usage status section 1702 indicates a usage status list 1721 of each physical storage apparatus, and indicates whether user data (physical page that is being used) is dispersed to multiple physical storage apparatuses 103 configuring the storage pool, or the user data is concentrated to a specific physical storage apparatus 103. In the example of FIG. 15C, the storage usage status section 1702 indicates, for each physical storage apparatus 103, a name of physical storage apparatus, a full capacity of a physical storage device, a capacity of a used physical storage device, a capacity of a free physical storage device of a physical storage apparatus, and a utilization ratio of a physical storage device. Further, the storage usage status section 1702 indicates a graph 1722 which expresses the utilization ratio of each physical storage apparatus 103.

The user input control program 702 is operable to retrieve the information (information on entire capacity and used capacity) which is indicated at the storage usage status section 1702 from the information regarding the capacity retrieved from the physical storage apparatus 103.

FIG. 15D illustrates a detailed example of the host usage status section 1703. The host usage status section 1703 indicates the information of the selected host computer 101 and the application program. In the example of FIG. 15D, the host computer HOST6 and the application program AP4 are selected. VVOL5, which is illustrated, is the only virtual volume to which the application program AP4 accesses. When multiple virtual volumes are accessed, the information of all of the virtual volumes is displayed.

In a chart 1731, “connection relation between host computer and physical storage apparatus” indicates whether the host computer 101 is directly connected to the physical storage apparatus 103 (whether an access path between the host—storage is defined), or indirectly connected using the inter physical storage apparatuses network.

“Number of inter physical storage apparatus communications” indicates the number of communications between the physical storage apparatuses 103 necessary for the host computer 101 to access the physical page of the physical storage apparatus 103. When a path over the host SAN 104 is defined between the host computer 101 and the physical storage apparatus 103, the number of inter apparatus communications is 0. “Physical page occupancy ratio” indicates a ratio of the physical pages occupied by the virtual volume with respect to the entire physical page at the physical storage apparatus 103.

The host usage status section 1703 further includes a schematic diagram 1732 which visualizes the above mentioned information. In the example of FIG. 15D, the information related to the host computer HOST6, HOST7, and the physical storage apparatuses SA1 to SA4 is schematically indicated. The user input control program 702 retrieves the necessary information to be displayed at the host usage status section 1703 from the communication performance of the inter physical storage apparatus, and the information indicating the relation of the storage pool, the virtual volume and the physical storage device, which are already retrieved.

Next, with respect to the virtual volume selected by the user, a user setting of a physical page placement policy will be described. The description below with reference to FIGS. 16A and 16B corresponds to the steps S203 to S205 of the flowchart in FIG. 14. As stated above, it is possible to carry out a user setting for the physical page allocation policy regarding the application program which is selected at the application usage status section 1701.

When the host cluster configuration of the selected application is the active—active configuration, the user input control program 702 displays the image of the physical page placement setting (active—active configuration) of FIG. 16A. When the host configuration of the selected application is the stand alone configuration, the user input control program 702 displays the image that has the same content as the physical page placement setting image (active—active configuration) of FIG. 16A.

When the host cluster configuration of the selected application is active—standby configuration, the user input control program 702 displays the image of the physical page placement setting (active—standby configuration) of FIG. 16B.

FIG. 16A indicates an example of an image 1810 of the physical page placement setting (active—active configuration). This is an image for carrying out a setting of a physical page placement when the host cluster of the selected application program has the active—active configuration. This setting image 1810 includes an environment section 1811 and a performance priority section 1812.

The environment section 1811 indicates a name (identifier) of a host computer, an identifier of the virtual volume, and a use for the virtual volume related to the application program whose setting is changed. The performance priority section 1812 includes a performance priority selection table 1813 arranged to specify the priority of a performance, and a physical page allocation ratio table 1814 arranged to indicate an allocation status of the physical page of each physical storage apparatus 103 when the priority specified in the performance priority selection table 1813 is selected.

The performance priority selection table 1813 indicates a degree of priority of a performance (high, mid, and low), and an estimated access speed which expresses an estimated value of an access speed for each degree of priority. A value for a dispersion ratio is associated in advance with respect to each value of the degree of priority. For example, “high priority” is defined as dispersion ratio 0% (the status in which physical pages are concentrated on certain multiple physical storage apparatuses), “mid priority” is defined as dispersion ratio 50%, and “low priority” is defined as dispersion ratio 100% (the status in which physical pages are equally dispersed to multiple physical storage apparatuses).

The user input control program 702 calculates the estimated access speed by the following method. The user input control program 702 determines the dispersion ratio from the value of each performance priority, and, by using it, calculates the physical page target placement ratio of each physical storage apparatus 103. The calculation of the physical page target placement ratio is executed at the step S204 of the flowchart in FIG. 14.

The user input control program 702 calculates the estimated access speed based on these values. For the calculation of the estimated access speed, a method same as the calculation method of the access speed which is described with reference to FIG. 15B may be used. In place of the ratio of the number of physical page, the physical page target placement ratio is used. The calculation method for the physical page target placement ratio will be described below.

The physical page allocation ratio table 1814 indicates a system utilization ratio which expresses the allocation ratio of the physical pages from the physical storage apparatus 103, and the ratio of the physical pages occupied out of the entire capacity within the physical storage apparatus 103. The user input control program 702 updates the information of the physical page allocation ratio table 1814 each time the radio button of the performance priority selection is changed. The “allocation ratio” indicates the physical page target placement ratio which is calculated at the performance priority selection table 1813. The “system utilization ratio” stores therein the value retrieved from the capacity management the information of the storage apparatus.

The calculation and display of the estimated access speed, as well as the update of the physical page allocation ratio table 1814 and the display of the updated information are executed by the step S204 of the flowchart in FIG. 14.

When the user selects a physical page placement setting execution button, the user input control program 702 has the information set at the performance priority selection table 1813 incorporated in the physical page dispersion ratio management table 709. When a cancel button is pressed, the user setting will be cancelled.

Here, the performance priority is described. The access performance with respect to the virtual volume changes depending on the physical storage apparatus 103 which places the physical page. For example, when the physical page is placed at the physical storage apparatus 103 to which an access path extends from the host computer 101, the access performance is high, while when the physical page is placed at the physical storage apparatus 103 to which an access path does not extend from the host computer 101, the access performance may possibly be lowered due to an occurrence of the inter storage apparatus communication.

That is, the performance changes depending on whether the physical pages are placed, in a concentrated manner, at the physical storage apparatus 103 to which an access path extends, or the physical pages are also placed, in a dispersed manner, at the physical storage apparatus 103 to which an access path does not extend.

Here, as an example, the management computer 102 determines, upon the specification from the user regarding the performance priority, the placement of the physical pages. As stated above, according to the present embodiment, the dispersion ratio is used in order to actualize the specified performance priority. The dispersion ratio is an index to express whether physical pages are placed at one or more specific storage apparatuses in a concentrated manner, or placed in a dispersed manner.

In the status with a low dispersion ratio, high performance may be expected from the access of the application program. However, there is a possibility that the physical pages (access) are concentrated at a specific physical storage apparatus 103, thereby the load on the physical storage apparatus 103 becomes heavy and the access performance of the physical storage apparatus 103 is lowered.

On the other hand, when the dispersion ratio is high, high performance is not expected since the ratio of the physical pages placed at the physical storage apparatus 103 from which high performance is not expected due to the occurrence of the inter physical storage apparatus communication is greater. However, since it becomes possible to prevent the physical pages from being concentrated at a specific physical storage apparatus 103, the possibility of lowering the performance of the physical storage apparatus 103 due to the heavy load being imposed on the specific physical storage apparatus 103 decreases.

In this example, with respect to the application program for which the required performance is high, based on the user input regarding the required performance of the application program, the ratio of the physical pages placed at the physical storage apparatus at which the inter physical storage apparatus communication does not occur is increased. By this, the access performance is designed to be improved.

On the other hand, with respect to the application program for which the required performance is low, the ratio of the physical pages placed at the physical storage apparatus at which the inter physical storage apparatus communication occurs is increased. By this, it is possible to prevent the concentration of the load on the physical storage apparatus due to the concentration of the physical pages at the specific physical storage apparatus.

FIG. 16B indicates an example of an image 1820 of the physical page placement setting (active—standby configuration). This is an image for carrying out a setting of a physical page placement when the host cluster of the selected application program has the active—standby configuration. This setting image 1820 includes an environment section 1821, a performance priority section 1822, and a post failover required performance section 1823.

The environment section 1821 and the performance priority section 1822 are the same as the environment section 1811 and the performance priority section 1812 shown in FIG. 16A. The performance priority section 1822 includes a performance priority selection table 1824 and a physical page allocation ratio table 1825.

The post failover required performance section 1823 includes a required performance selection table 1826 arranged to set, in the case of an active—standby configuration, an extent of performance required after a failover. The required performance selection table 1826 indicates a post failover required performance, and a post failover estimated access speed. In the present embodiment, the post failover required performance is associated with the physical page target placement ratio between the active host computer 101 and the standby host computer 101.

When the user presses the physical page placement setting execution button, the user input control program 702 has the information which is set at the required performance selection table 1826 reflected on the active—standby configuration physical page target placement ratio management table 708, and has the information which is set at the performance priority selection table 1824 reflected on the physical page dispersion ratio management table 709. When the cancel button is pressed, the user setting will be cancelled.

The post failover required performance will be described. In the active—standby configuration, the performance changes before and after a failover depending on the physical storage apparatus 103 which places the physical page.

For example, in the active—standby configuration, when the physical pages are placed in a concentrated manner at the physical storage apparatus 103 to which an access path extends from the host computer 101 in an active status, and the physical storage apparatus does not have an access path extended from the host computer 101 in a standby status, there is a possibility that the performance of the host computer 101 in the standby status is lowered than the performance of the host computer in the active status.

On the other hand, when the physical pages are placed equally at the storage apparatus to which an access path extends from the host computer in an active status and the storage apparatus to which an access path extends from the host computer in a standby status, it is expected that the performance of the host computer 101 in the active status and the performance of the host computer 101 in the standby status are at the same level.

Thus, the management computer 102 accepts the specification from the user on the post failover required performance, and determines, based on the specification, the placement of the physical page. Selectable post failover required performance may include, for example, “same level as pre failover”, “slightly lower than pre failover”, or “no request”, or may indicate “lower by X % than pre failover”.

Note that in order to actualize this function, the storage apparatus control program 701 manages to what extent the physical pages are placed at the active host computer and the standby host computer each. The active—standby configuration physical page target placement ratio management table 708 indicated in FIG. 12 manages this information.

An example of a value to be set at the active—standby configuration physical page target placement ratio management table 708 for “active side target placement ratio” and “standby side target placement ratio” is indicated below.

When the value of the post failover required performance specified by the user is the “same level as pre failover,” “active side target placement ratio”=“standby side target placement ratio”=50%. When the value is “slightly lower,” “active side target placement ratio”=50+α%, “standby side target placement ratio”=50−α%. When the value is “no request,” “active side target placement ratio”=50+β%, “standby side target placement ratio”=50−β%. Note that α>β.

Returning to the flowchart in FIG. 14, at the step S203, the user input control program 702 receives, as described with reference to FIG. 16A and FIG. 16B, a user specification on the dispersion ratio when the host configuration is either active—active cluster configuration or stand alone configuration, and receives a user specification on the dispersion ratio as well as the active side target placement ratio and the standby side target placement ratio when the host configuration is active—standby cluster configuration.

At the step S204, the access path target access ratio update module 725 and the physical page target placement ratio update module 724 refer to the user setting, and calculate the physical page target placement ratio of each physical storage apparatus 103. As described with reference to FIG. 16A and FIG. 16B, the user input control program 702 uses these values in order to calculate the estimated access speed of the performance priority selection tables 1813 and 1824, and the required performance selection table 1826, and the allocation ratio of the physical page allocation ratio tables 1814 and 1825.

Further, at the step S205, as described with reference to FIG. 16A and FIG. 16B, the user input control program 702 updates, based on the value which is calculated as stated above, the display for the performance priority selection tables 1813 and 1824, the required performance selection table 1826, and the physical page allocation ratio tables 1814 and 1825.

At the step S106, the physical page placement setting module 726 determines the final physical page target placement ratio of each physical storage apparatus 103, and gives an instruction to all of the physical storage apparatuses 103 or to a portion of selected physical storage apparatus 103.

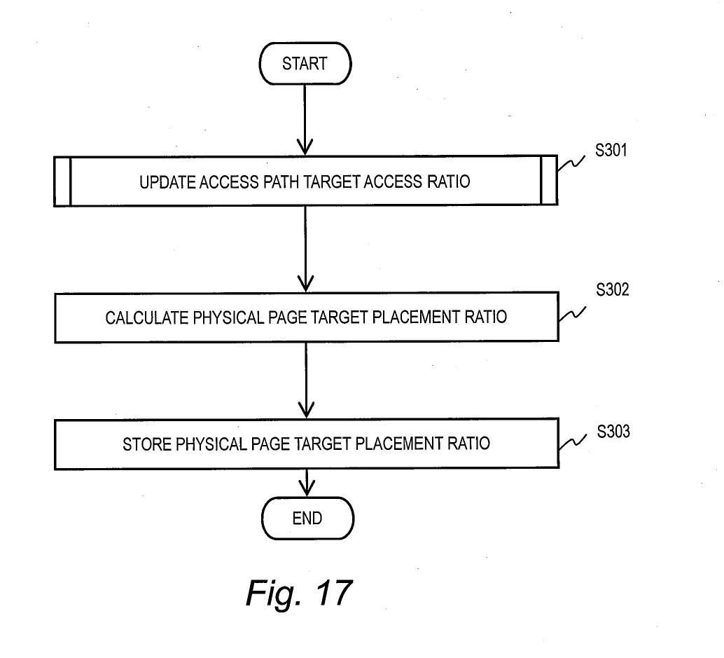

Hereafter, the calculation method of the physical page target placement ratio carried out at the step S204 will be described. The physical page target placement ratio update module 724 determines the physical page target placement ratio of each physical storage apparatus 103. FIG. 17 is a flowchart indicating an example of a process of the physical page target placement ratio update module 724. The physical page target placement ratio update module 724 executes this process with respect each virtual volume of the selected application program.

In the flowchart in FIG. 17, the physical page target placement ratio update module 724 invokes the access path target access ratio update module 725, and updates the access path target access ratio (S301). At the step S301, the access path target access ratio update module 725 calculates the target access ratio for each access path with respect to the virtual volume.

The physical page target placement ratio update module 724 calculates, by using the target access ratio for each access path, which is calculated by the access path target access ratio update module 725, the physical page target placement ratio of each physical storage apparatus 103 (S302). The physical page target placement ratio update module 724 stores the calculated physical page target placement ratio at the physical page target placement ratio management table 707 (S303).

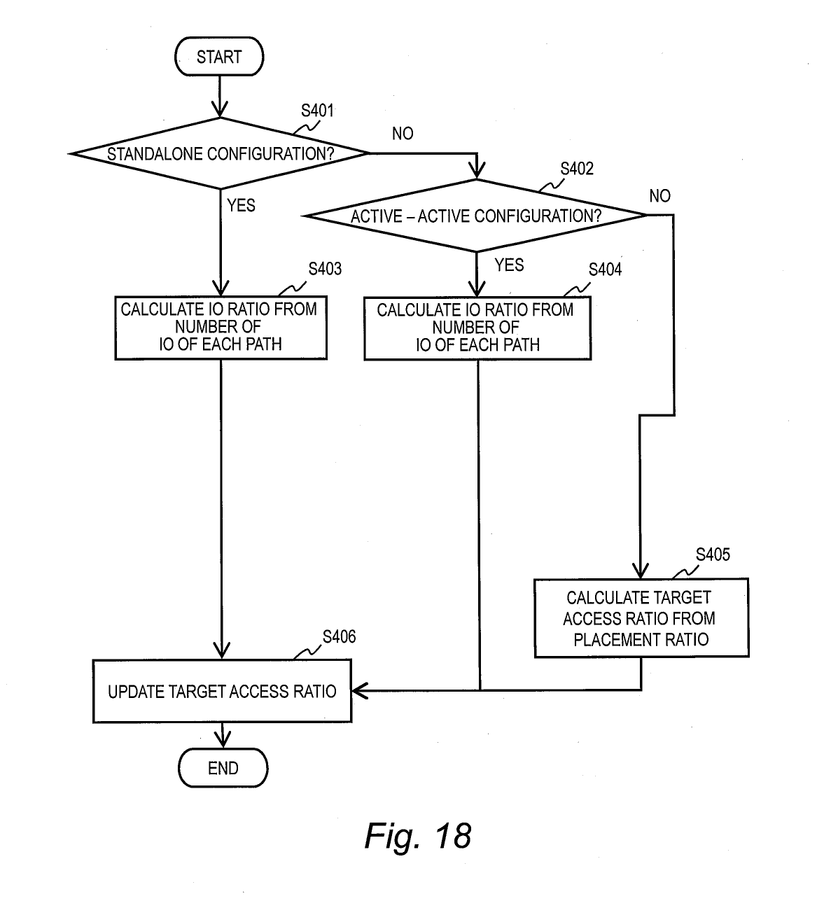

As stated above, the physical page target placement ratio is calculated from the access path target access ratio. Hereafter, the calculation method of the access path target access ratio will be described. FIG. 18 is a flowchart indicating an example of a process of the access path target access ratio update module 725. The calculation method of the target access ratio differs depending on the host configuration. The access path target access ratio update module 725 specifies the host configuration of the host computer 101 which accesses to the virtual volume, and calculates the target access ratio in accordance with the host configuration.

In the flowchart of FIG. 18, the access path target access ratio update module 725 determines whether the host configuration is the standalone configuration, the active—active cluster configuration, or the active—standby cluster configuration (S401, S402).

When the host configuration is the standalone configuration (S401: YES), the access path target access ratio update module 725 calculates, via the step S403, the target access ratio. When the host configuration is the active—active cluster configuration (S401: NO, S402: YES), the access path target access ratio update module 725 calculates, via the step S404, the target access ratio.

When the host configuration is the active—standby cluster configuration (S401: NO, S402: NO), the access path target access ratio update module 725 calculates, via the step S405, the target access ratio. The access path target access ratio update module 725 updates the path management table 705 based on the calculated target access ratio (S406).

The calculation method of the target access ratio for the standalone configuration will be described. The access path target access ratio update module 725 calculates the target access ratio from the I/O ratio of each access path to the virtual volume. When there is a plurality of access paths, in this context, all of them are treated as active.

To be more specific, the access path target access ratio update module 725 retrieves an IOPS measured value of all of the access paths to the virtual volume from the path management table 705, and calculates the sum thereof. The access path target access ratio update module 725 divides the. IOPS of each access path to the virtual volume by the aforementioned sum in order to calculate the IOPS ratio (I/O ratio) of each access path. Each the IOPS ratio is the target access ratio of each access path. The target access ratio agrees with the measured value of the IOPS ratio.

Next, the calculation method of the target access ratio for the active—active cluster configuration will be described. In this current example, this will be the same the calculation method for the target access ratio for the standalone configuration. That is, the access path target access ratio update module 725 calculates the target access ratio from the I/O ratio of each access path to the virtual volume. In the active—active cluster configuration, all accesses to the virtual volume are active.

Next, the calculation method of the target access ratio for the active—standby cluster configuration will be described. The access path target access ratio update module 725 calculates the target access ratio from the active side target placement ratio and the standby side target placement ratio specified by the user.

To be more specific, the access path target access ratio update module 725 retrieves the value for the active side target placement ratio and the value for the standby side target placement ratio with respect to the virtual volume from the active—standby configuration physical page target placement ratio management table 708. Further, by using the following formula, the target access ratio of each access path to the virtual volume is calculated.

(target access ratio of each access path to virtual volume from host computer X)=(target placement ratio of host computer X)/(number of access path from host computer X to virtual volume)

The target placement ratio of the host computer X is the active side target placement ratio when the host computer X is the active host computer, and the standby side target placement ratio when the host computer X is the standby host computer.

When there are multiple active host computers or standby host computers, the target placement ratio of the host computer X is either the value obtained from dividing the active side target placement ratio by the number of the active host computer, or the value obtained from diving the standby side target placement ratio by the number of the standby host computer.

As stated above, the access path target access ratio update module 725 calculates the target access ratio of each access path based on the usage status of the access path. That is, in the above stated example, the access path target access ratio update module 725 determines the target access ratio of the access path based on the user setting or the I/O measured value.

In the above mentioned example, in the stand along configuration and the active—active cluster configuration, as the I/O measured value used to calculate the target access ratio of each access path, the measured value of the number of I/O (the number of I/O requests) will be used. The access path target access ratio update module 725 may use the measured value of the I/O data amount (the amount of data of user data at I/O), instead of the measured value of the number of I/O data, as the I/O measured value to calculate the target access ratio.

The access path target access ratio update module 725 may determine, in place of the I/O measured value, the target access ratio of the access path based on a path switching algorithm (access algorithm). The access algorithm also is one of the elements to indicate the usage status of the access path. The multipath management program 116 of the host computer 101 selects, in accordance with the algorithm, the access path which is used for the issuance of the I/O request.

For example, when the access algorithm is round robin, the target access ratio of the active access path is an even ratio. For example, when there are two active paths, their target access ratio is 0.5. For the algorithm whose selectivity of the access path is 7 to 3, the target access ratio of the access path agrees with such ratio.

The management computer 102 has the information, which associates each access algorithm with the target access ratio, in advance, refers to such information, and determines the target access ratio corresponding to the access algorithm. By this, it becomes possible to determine the appropriate target access ratio in accordance with the access algorithm.

With respect to the host computer 101 of the standalone configuration, there are occasions where only one access path is connected thereto, and there are occasions where an access path cluster made from a plurality of access paths is connected thereto. In the above stated example, although all of the access paths of the plurality of access paths are active, a portion of the access paths may be active while the rest of the access paths are on standby. The calculation method of the target access ratio for the above stated active—standby cluster configuration may be applied to this configuration.

In a configuration in which the plurality of access paths include multiple access paths that are active and at least one access path that is on standby, together with the calculation method for the target access ratio at the above stated active—standby cluster configuration, the calculation method for the above stated active—active cluster configuration may be applied to the multiple access paths that are active.

Next, a method to calculate the physical page target placement ratio of the physical storage apparatus 103 from the target access ratio of the access path will be described. The physical page target placement ratio update module 724 retrieves the calculated target access ratio for each access path from the path management table 705.

Next, the physical page target placement ratio update module 724 calculates the physical page target placement ratio of each physical storage apparatus 103 by the following formula. The physical page target placement ratio of one physical storage apparatus 103 is a sum of the target access ratio of all access paths of the selected virtual volume, which is connected to the physical storage apparatus 103, and may be calculated by the following formula.

(target placement ratio of physical storage apparatus X)=Σ(target access ratio of access path connected to physical storage apparatus X)

Next, the value for the dispersion ratio of the virtual volume is retrieved from the physical page dispersion ratio management table 709. The physical page target placement ratio update module 724 calculates the physical page target placement ratio of each physical storage apparatus 103 upon taking the dispersion ratio which is set for the virtual volume into consideration. When the dispersion ratio is high, the bias between the physical storage apparatuses of the physical page becomes small. When the dispersion ratio is low, there is a great possibility that the bias between the physical storage apparatuses of the physical page becomes large.

The physical page target placement ratio of the physical storage apparatus X after considering the dispersion ratio is calculated by the following formula.

(physical page target placement ratio of physical storage apparatus X after considering dispersion ratio)=100*(pre normalization physical page target placement ratio of physical storage apparatus X)/(normalization denominator)

Since not all of the sums of the pre normalization placement ratio of the physical storage apparatus will be 100%, they are divided by the normalization denominator in order for normalization. The normalization denominator is obtained from the following formula. Σ is a sum for all physical storage apparatus.

(normalization denominator)=Σ(pre normalization target placement ratio of physical storage apparatus X)

The pre normalization physical page target placement ratio of the physical storage apparatus X is calculated by the following formula.

(pre normalization placement ratio of physical storage apparatus X)=(target placement ratio of physical storage apparatus X)−(target placement ratio of physical storage apparatus X−average placement ratio)*(dispersion ratio/100)

The average placement ratio is a ratio of when the physical page is placed equally to all of the physical storage apparatus configuring the virtual storage apparatus, and is obtained by the following formula.

(average placement ratio)=100/(total number of physical storage apparatus)

For example, when there are 4 physical storage apparatuses, the average placement ratio would be 100/4=25%.

As the dispersion ratio increases the target placement ratio of each physical storage apparatus becomes closer to the average placement ratio, and, when the dispersion ratio is 100%, the target placement ratio of each physical storage apparatus agrees with the average placement ratio.

An example will be described. For example, suppose that the placement ratio of physical storage apparatus A is 70, the placement ratio of physical storage apparatus B is 20, the placement ratio of physical storage apparatus C is 5, the placement ratio of physical storage apparatus D is 5, and the dispersion ratio is 50% (0.5). The pre normalization placement ratio of each physical storage apparatus is calculated as follows.

(pre normalization placement ratio of physical storage apparatus A)=70−(70−25)*0.5=47.5

(pre normalization placement ratio of physical storage apparatus B)=20−(20−25)*0.5=22.5

(pre normalization placement ratio of physical storage apparatus C)=5−(5−25)*0.5=15

(pre normalization placement ratio of physical storage apparatus D)=5−(5−25)*0.5=15

The normalization denominator is calculated as follows.

(normalization denominator)=70+20+5+5=100

The pre normalization placement ratio of each physical storage apparatus after considering the dispersion ratio is calculated as follows.

(pre normalization placement ratio of physical storage apparatus A after considering dispersion)=47.5/100*100=47.5

(pre normalization placement ratio of physical storage apparatus B after considering dispersion)=22.5/100*100=22.5

(pre normalization placement ratio of physical storage apparatus C after considering dispersion)=15/100*100=15

(pre normalization placement ratio of physical storage apparatus D after considering dispersion)=15/100*100=15

As described above, according to the present embodiment in which the physical page from the Thin Provisioning Pool which operates over multiple physical storage apparatuses is allocated to the virtual volume, when newly allocating a physical page to the virtual volume when its capacity is expanding, it becomes possible, by considering the access path configuration and the access path usage status between one or multiple host computers and multiple physical storage apparatuses, to appropriately select the physical storage apparatus which allocates the physical page to the virtual volume.

While the present invention has been described in detail with reference to attached drawings, the present invention is not limited to the specific configurations described above. The present invention is intended to include various modifications and comparable structures within the scope of the appended claims.

For example, although according to the above stated example the user setting and the target placement ratio are determined with respect to all virtual volumes of the selected application program, in another example, the same process may be carried out with respect to one selected virtual volume, for example. The technique in connection with the cluster of the above mentioned host computer may be applied to a system which includes a clustered physical storage apparatus.

Although in the above stated example the user specification regarding the dispersion ratio, the active side target placement and the standby side target placement ratio are accepted, in another example of the present invention the user specification may not be accepted. In another example of the present invention, the dispersion ratio may be applied to the relation between the physical storage apparatus connected to the standby path and the physical storage apparatus not connected to the standby path.

What is claimed is:

1. A computer system including a plurality of physical storage apparatuses, one or more host computers and a management computer connected with one another, the management computer managing actual storage areas provided by the plurality of physical storage apparatuses as a single storage pool, the computer system allocating an actual storage area to a virtual volume used by the one or more host computers from the storage pool when writing data to the virtual volume from the host computer,
wherein the management computer is configured to retain access path management information including information of a configuration of access paths between the plurality of physical storage apparatuses and the one or more host computers, and information of usage status of the access paths,
wherein the management computer is configured to identify, based on the access path management information, access paths for access from the one or more host computers to the virtual volume and usage status of the access paths for access to the virtual volume,
wherein the management computer is configured to determine, based on the usage status of the access paths, target capacity ratios of actual storage areas allocated to the virtual volume from the plurality of physical storage apparatuses providing actual storage areas to the storage pool, and
wherein the plurality of physical storage apparatuses are configured to allocate actual storage areas to the virtual volume based on an actual storage area capacity already allocated to the virtual volume from each of the plurality of physical storage apparatuses and the target capacity ratios.

2. The computer system according to claim 1,
wherein a plurality of host computers are connected with the plurality of physical storage apparatuses and the management computer, and
wherein the actual storage area allocated to the storage pool is a page of a management storage area unit for the storage pool.

3. The computer system according to claim 2,
wherein a plurality of active paths currently used for the access to the virtual volume exist,
wherein the usage status indicates an I/O measured value for each of the plurality of active paths, and
wherein the management computer is configured to determine, based on ratios of the I/O measured values for the plurality of active paths, the target capacity ratios.

4. The computer system according to claim 2,
wherein only a portion of the plurality of physical storage apparatuses is connected to the plurality of host computers via the access paths, and
wherein when determining the target capacity ratios, a target capacity ratio of a physical storage apparatus to which an access path is not connected is determined in accordance with a setting specified in advance.

5. The computer system according to claim 2,
wherein a plurality of active paths currently used for access to the virtual volume exist,
wherein the usage status indicates an algorithm for switching of the plurality of active paths, and
wherein the management computer is configured to determine, based on the algorithm, the target capacity ratios.

6. The computer system according to claim 2,
wherein the usage status of the access path indicates an active path currently used for access to the virtual volume, and a standby path currently not used for access to the virtual volume,
wherein a target capacity ratio of actual storage areas allocated to the virtual volume by a physical storage apparatus connected to the active path, and a target capacity ratio of actual storage areas allocated to the virtual volume by a physical storage apparatus connected to the standby path are set by a user in advance, and
wherein the management computer is configure to determine, based on the target capacity ratios set by the user, the target capacity ratios of actual storage areas allocated to the virtual volume from the plurality of physical storage apparatuses.

7. A method for managing actual storage areas provided by a plurality of physical storage apparatuses as a single storage pool, and allocating, when writing, by one or more host computers, data to a virtual volume used by the one or more host computers, an actual storage area from the storage pool to the virtual volume, the method comprising:
identifying, based on access path management information including information of a configuration of access paths between the plurality of physical storage apparatuses and the one or more host computers and information of usage status of the access paths, access paths for access to the virtual volume from the one or more host computers and usage status of the access paths;
determining, based on the usage status of the access paths, target capacity ratios of the actual storage area allocated to the virtual volume from the plurality of physical storage apparatuses providing the actual storage areas to the storage pool; and
allocating actual storage areas to the virtual volume based on an actual storage area capacity already allocated to the virtual volume from each of the plurality of physical storage apparatuses and the target capacity ratios.

8. The method according to claim 7,
wherein the plurality of host computers are connected to the plurality of physical storage apparatuses and the management computer, and
wherein the actual storage area allocated to the storage pool is a page of a management storage area unit for the storage pool.

9. The method according to claim 8,
wherein a plurality of active paths currently used for the access to the virtual volume exist,
wherein the usage status indicates an I/O measured value for each of the plurality of active paths, and
wherein based on ratios of the I/O measured values for the plurality of active paths, the target capacity ratios are determined.

10. The method according to claim 8,
wherein only a portion of the plurality of physical storage apparatuses is connected with the plurality of host computers via the access path, and
wherein in accordance with a setting specified in advance, a target capacity ratio of a physical storage apparatus to which an access path is not connected is determined.

11. The method according to claim 8,
wherein a plurality of active paths currently used for access to the virtual volume exist,
wherein the usage status indicates an algorithm for switching of the plurality of active paths, and
wherein based on the algorithm the target capacity ratios are determined.

12. The method according to claim 8,
wherein the usage status of the access path indicates an active path currently used for access to the virtual volume, and a standby path currently not used for access to the virtual volume,
wherein a target capacity ratio of actual storage areas allocated to the virtual volume by a physical storage apparatus connected to the active path, and a target capacity ratio of actual storage areas allocated to the virtual volume by a physical storage apparatus connected to the standby path are set by a user in advance, and
wherein based on the target capacity ratios set by the user, the target capacity ratios of actual storage areas allocated to the virtual volume by the plurality of physical storage apparatuses are determined.
